(19) United States
(12) Patent Application Publication
(10) Pub. No.: US 2026/0278336 A1
(43) Pub. Date: Sep. 17, 2026

(54) METHOD, APPARATUS, SYSTEM AND READABLE STORAGE MEDIUM FOR TIME SERIES ANALYSIS

(71) Applicant: Huawei Technologies Co., Ltd., Shenzhen (CN)

(72) Inventors: Wen Tong, Ottawa (CA); Yiqun Ge, Ottawa (CA); Wuxian Shi, Ottawa (CA)

(21) Appl. No.: 19/671,716

(22) Filed: May 8, 2026

Related U.S. Application Data
(63) Continuation of application No. PCT/CN2024/105028, filed on Jul. 11, 2024.
(60) Provisional application No. 63/598,376, filed on Nov. 13, 2023.

(51) Int. Cl. G06N 3/045; G06N 3/08

(52) U.S. Cl. CPC G06N 3/045; G06N 3/08

(57) ABSTRACT

The present disclosure provides a method, apparatus, system and readable storage medium for time series (TS) analysis. An example method includes: obtaining TS data; and performing TS analysis on the TS data based on a first model to obtain TS analysis result. When the TS data is of a first type, the first model includes a first embedded encoder corresponding to the first type; or when the TS data is of a second type, the first model includes a second embedded encoder corresponding to the second type.

### CROSS-REFERENCE TO RELATED APPLICATIONS

The present application is a continuation of International Application No. PCT/CN2024/105028, filed on Jul. 11, 2024, which claims priority to and the benefit of U.S. Provisional Patent Application Ser. No. 63/598,376, entitled “Universal Multi-Modal Multi-Source Time Series Analysis Engine in Wireless Systems using Pre-Trained Large Language Models,” filed on Nov. 13, 2023, the entire contents of both of which applications are incorporated herein by reference.

### TECHNICAL FIELD

The present disclosure relates to the data analysis field, and in particular, to a method, apparatus, system and readable storage medium for time series analysis.

### BACKGROUND

With the development of communication system and artificial intelligence technology, the future of real-time time series (TS) analysis being increasingly applied in wireless communication systems is foreseeable.

The base station may comprise a TS analysis engine, to which the user equipment (UE) can access in order to perform TS analysis of specific data. However, different scenario may generate different type of TS data, which requires the usage of different TS analysis methods. This results in a challenge to the processing ability of the TS analysis engine. In other words, the TS analysis engine may not have the ability to analyze all types of TS data, or the analysis may take a long time.

As an example, the TS analysis engine may need to analyze multiple types of TS data, e.g. weather TS data collected by meteorological stations, vehicle TS data collected by vehicles, and other modes of TS data in other scenarios. When dealing with new TS data types, TS analysis model of the TS analysis engine may need to be retrained based on the new data types, which results in a significant amount of resources and time consumption.

### SUMMARY

For the foregoing problems, described is a method, apparatus, system and readable storage medium for time series analysis.

According to a first aspect, described is a time series (TS) analysis method applied to a first device, comprising: obtaining TS data; performing TS analysis on the TS data based on a first model to obtain TS analysis result, wherein: when the TS data is of a first type, the first model includes a first embedded encoder corresponding to the first type; or when the TS data is of a second type, the first model includes a second embedded encoder corresponding to the second type.

According to some implementations, utilizing specialized encoders tailored for various TS data types enables customized processing, thereby enhancing the adaptability of TS analysis to the specific characteristics of the data. This approach may allow the analysis to obtain the desired TS outcomes with improved precision and efficiency. This targeted approach optimizes performance by extracting specific patterns and trends, leading to more effective analysis and decision-making. Besides, analyzing different types of TS data through a single model not only avoids the complex process of training and using multiple models but also enhances model integration.

In a possible implementation manner of the first aspect, the first model further includes a large language model (LLM), and the performing TS analysis on the TS data based on a first model comprises: converting the TS data into TS semantic embedding feature data by the first embedded encoder or the second embedded encoder; and processing the TS semantic embedding feature data with the LLM of the first model to obtain the TS analysis result.

In a possible implementation manner of the first aspect, the performing a TS analysis on the TS data based on a first model, comprising: performing TS analysis on the TS data based on the first model and a soft prompt, wherein: when the TS data is of the first type, the soft prompt is a first soft prompt; or when the TS data is of the second type, the soft prompt is a second soft prompt.

In a possible implementation manner of the first aspect, the first model dynamically updates the parameters of the first model based on the TS data received.

In a possible implementation manner of the first aspect, the first device includes a network device of a communication system, and the communication system further includes a second device, the second device includes a terminal device.

In a possible implementation manner of the first aspect, the method further comprising: sending a TS analysis request to the second device; and wherein the obtaining TS data, comprises: receiving a first data from the second device, wherein the first data is TS data or a first part of the TS data.

In a possible implementation manner of the first aspect, the method further comprising: receiving a TS analysis request from the second device; sending a grant message to the second device.

In a possible implementation manner of the first aspect, the communication system further includes a sensor, and the obtaining TS data, comprises: obtaining a second data from the sensor, wherein the second data is TS data or a second part of the TS data.

In a possible implementation manner of the first aspect, the method further comprises: sending the TS analysis result to the second device.

According to a second aspect, described is a time series (TS) analysis method applied to a second device, comprising: processing TS data with an embedded encoder to obtain TS semantic embedding feature data, wherein: when the TS data is of a first type, the embedded encoder is a first embedded encoder corresponding to the first type; or when the TS data is of a second type, the embedded encoder is a second embedded encoder corresponding to the second type; sending the TS semantic embedding feature data to the first device.

According to some implementations, utilizing specialized encoders tailored for various TS data types enables customized processing, thereby enhancing the adaptability of TS analysis to the specific characteristics of the data. This approach may help the analysis to obtain the desired TS outcomes with improved precision and efficiency. This targeted approach optimizes performance by extracting specific patterns and trends, leading to more effective analysis and decision-making.

In a possible implementation manner of the second aspect, the method further comprises: determining a soft prompt, wherein: when the TS data is of the first type, the soft prompt is a first soft prompt; and when the TS data is of the second type, the soft prompt is a second soft prompt; sending the soft prompt to the first device.

In a possible implementation manner of the second aspect, the first device includes a network device of a communication system, the communication system further includes a second device, and the second device includes a terminal device.

In a possible implementation manner of the second aspect, the method further comprises: receiving a TS analysis request from the second device.

In a possible implementation manner of the second aspect, the method further comprising: sending a TS analysis request to the first device; receiving a grant message from the second device.

In a possible implementation manner of the second aspect, the method further comprises: The first device sending the TS analysis result to the second device.

According to a third aspect, described is a time series (TS) analysis method applied to a first device, comprising: performing TS analysis on the TS semantic embedding feature data to obtain TS analysis result.

According to some implementations, the first device does not need to perform transformations on the TS data; it can directly conduct TS analysis based on the already transformed TS semantic embedding feature data, thereby reducing the computational load on the first device.

In a possible implementation manner of the third aspect, the performing TS analysis on the TS semantic embedding feature data, further comprises: processing the TS semantic embedding feature data with a large language model (LLM).

In a possible implementation manner of the third aspect, the performing TS analysis on the TS semantic embedding feature data, further comprises: performing TS analysis on the TS semantic embedding feature data based on the first soft prompt or the second soft prompt.

In a possible implementation manner of the third aspect, the LLM dynamically updates based on the TS semantic embedding feature data received by the first device.

According to a fourth aspect, described is a time series (TS) analysis apparatus for use in a wireless communication system, comprising means for performing the method described.

According to a fifth aspect, described is a wireless communication system, comprising: a base-station, configured to: obtain TS data; perform TS analysis on the TS data based on a first model to obtain TS analysis result, wherein: when the TS data is of a first type, the first model includes a first embedded encoder correspond to the first type; or when the TS data is of a second type, the first model includes a second embedded encoder correspond to the second type; a user equipment (UE), configured to: collect a first data and send the first data to the base-station, wherein the first data is TS data or a first part of the TS data.

According to a sixth aspect, described is a wireless communication system, comprising: a base-station, configured to: perform TS analysis on the TS semantic embedding feature data to obtain TS analysis result; a user equipment (UE), configured to: process TS data with an embedded encoder to obtain TS semantic embedding feature data, wherein: when the TS data is of a first type, the embedded encoder is a first embedded encoder correspond to the first type; or when the TS data is of a second type, the embedded encoder is a second embedded encoder correspond to the second type; send the TS semantic embedding feature data to the first device.

According to a seventh aspect, described is a non-transitory computer readable medium comprising program instructions for causing an apparatus to perform the method described.

### BRIEF DESCRIPTION OF THE DRAWINGS

The foregoing summary, as well as the following detailed description of the embodiments, will be better understood when read in conjunction with the appended drawings. However, the present disclosure is not limited to the precise arrangements and instrumentalities shown.

FIG. 1 illustrates a schematic diagram of a large language model (LLM) according to some examples.

FIG. 2 illustrates a schematic diagram of re-training and fine-tuning for LLM according to some examples.

FIG. 3 illustrates a schematic diagram of a wireless system according to some examples.

FIG. 4 illustrates a schematic diagram of a wireless system with time series (TS) analysis engine according to some examples.

FIG. 5 illustrates a schematic diagram of integrating TS analysis engine into a base station according to some examples.

FIG. 6 illustrates a schematic diagram of modified LLM and soft prompt according to some examples.

FIG. 7 illustrates a schematic flowchart of executing a TS analysis for either base station or UE according to some examples.

FIG. 8 illustrates a schematic diagram of multi-source TS analysis with modified LLM according to some examples.

FIG. 9 illustrates a schematic diagram of multi-modality TS analysis with modified LLM according to some examples.

FIG. 10 illustrates a schematic flowchart of a base-station-centric operation sequential procedure according to some examples.

FIG. 11 illustrates a schematic flowchart of a UE-centric operation sequential procedure according to some examples.

FIG. 12 illustrates a schematic diagram of UE generating its own embedding semantics and soft-prompts according to some examples.

FIG. 13 illustrates a schematic diagram of an UE-centric operation sequential procedure but embedding semantics and soft-prompts generated by the UE according to some examples.

FIG. 14 illustrates a schematic diagram of a life-cycle of embedding encoders and soft-prompt generators according to some examples.

FIG. 15 illustrates a schematic structural diagram of an electronic device 1000 according to some examples.

FIG. 16 illustrates a schematic diagram of a communication system according to some examples.

FIG. 17 illustrates a schematic diagram of more detailed example for communication system according to some examples.

FIG. 18 illustrates a schematic diagram of an apparatus wirelessly communicating with at least one of two apparatuses in a communication system according to some examples.

FIG. 19 illustrates a schematic diagram of units or modules in a device or apparatus according to some examples.

### DETAILED DESCRIPTION OF ILLUSTRATIVE EMBODIMENTS

Illustrative embodiments include, but are not limited to a method, system, apparatus, and readable storage medium for time series analysis.

In order to better illustrate the embodiments, the following will first introduce some terms.
(1) Time Series (TS): A time series is a sequence of data points or signals, typically ordered in time intervals, used to study patterns, trends, and forecast future values in various domains.
(2) Tokens in LLM: In LLM, tokens are the smallest units of text that the model reads, often corresponding to words, subwords, or characters.
(3) Embedder (or embedding encoder): An embedder, or embedding encoder, transforms these tokens into continuous vector representations called (semantic) embeddings, capturing their semantic essence for the model's processing and understanding.
(4) Autoencoder: An autoencoder is a neural network architecture used for unsupervised learning of efficient codings. It compresses input data into a compact representation and then reconstructs the original data from this representation. In the context of the provided document, it can be seen as a mechanism to generate (semantic) embeddings or compact representations of TS data for further processing by models like LLMs.
(5) Contrastive Learning: Contrastive learning is a technique that trains models to distinguish between similar and dissimilar data points. In the context of an autoencoder, it can be employed to help ensure that the compact representations (or embeddings) of similar data points are brought closer together in the embedding space, while those of dissimilar data points are pushed apart. This may help enhance the quality of the embeddings by emphasizing meaningful differences and similarities in the data.
(6) Prompt in LLM: In the context of LLM, a prompt is a predefined input designed to guide the model's response or behavior.
(7) Base Station: A central radio equipment in wireless communication systems that facilitates communication with mobile devices.
(8) User Equipment (UE): In wireless telecommunications, UE refers to any device used directly by an end-user to communicate. It encompasses, for example, mobile phones, tablets, and other portable gadgets that connect to a wireless network.
(9) Uplink (UL): The communication channel or path used for transmitting data from a UE to a base station or network.
(10) Downlink (DL): The communication channel or path used for transmitting data from a base station or network to a UE.
(11) Physical Channels: These are channels that carry information on the air interface between the UE and the base station.

### Downlink:

Physical Broadcast Channel (PBCH): Used by UE for cell acquisition, selection, and re-selection.

Physical Downlink Control Channel (PDCCH): Schedules transmissions on the Physical Downlink Shared Channel (PDSCH) and the Physical Uplink Shared Channel (PUSCH).

Physical Downlink Shared Channel (PDSCH): Adaptable to current link conditions and carries a variety of transport channels.

### Uplink:

Physical Random Access Channel (PRACH): Used by UE for initial access to the network.

Physical Uplink Control Channel (PUCCH): Carries uplink control information.

Physical Uplink Shared Channel (PUSCH): Adaptable to link conditions and carries logical channels like CCCH, DCCH, and DTCH.

### Control Messages:

Downlink Control Information (DCI): Does scheduling for PDSCH and PUSCH and carries Transmit Power Control (TPC) commands.

Uplink Control Information (UCI): Carries channel reports, HARQ-ACK, and scheduling requests. It can be transmitted on both PUCCH and PUSCH.
(12) Edge: In wireless communication, the term “edge” refers to the boundary or interface between different networks or between a network and the end-user devices. An edge device is any piece of hardware that controls the flow of data at the boundary between two networks. Edge devices can serve various roles, such as transmission, routing, processing, monitoring, filtering, and storage of data passing between networks. With the rise of cloud computing, the Internet of Things (IoT), and the increasing demand for real-time data processing, the concept of edge computing has emerged. In edge computing, processes may be decentralized, occurring closer to the location where they are needed, which can be at the edge of the network. Additionally, with advancements in artificial intelligence (AI), edge devices may now be equipped with AI capabilities, enabling them to potentially process and analyze data locally, potentially reducing latency and allowing faster decision-making.

This application addresses the challenges of real-time TS analysis (including prediction) in modern wireless systems. It introduces solutions for integrating a universal TS analysis engine at base-station, which is accessible to UEs. By leveraging LLMs and customized embedding encoders and prompts, the current application offers a flexible and efficient approach to handle diverse TS data types (modalities). The embodiments presented cater to both base-station-centric and UE-centric operations, providing a comprehensive solution to the evolving demands of wireless communication

This application presents a novel approach to implement time series (TS) analysis engine within wireless systems by harnessing the capabilities of large language models (LLMs). At its core, the idea revolves around integrating a universal TS analysis engine at the base-station, which is accessible to UEs. By customizing embedding encoders and utilizing soft-prompts, the system can adapt to diverse TS data types without the need for extensive re-training of the LLM. This adaptive framework may help optimize wireless operations but also enhance the overall user experience by allowing for more timely and accurate predictions. The wireless physical channels and controlling messages are involved the transmission of TS data or request, which can help provide a real-time, multi-source TS analysis engine.

As mentioned before, with the increasing functionality of wireless systems, there are many scenarios for TS analysis in wireless systems.

In the rapidly evolving landscape of wireless technology, TS analysis may play a dual role. Firstly, it may serve as a tool for optimizing the wireless system itself, potentially providing efficient data transmission, reduced interference, and seamless handovers. Secondly, it may enhance the applications that run on these wireless systems, from IoT devices to mobile applications, helping them to operate at peak efficiency and offer users a superior experience. As we venture further into the digital age, we can anticipate the emergence of new types of TS data. These novel datasets, born from innovations in wireless communication and its applications, will present fresh challenges and opportunities, underscoring the continued significance of TS analysis in shaping the future of wireless systems.

With the evolution of wireless systems, there's a burgeoning demand for Ultra-Reliable Low-Latency Communication (URLLC). As applications become more real-time and critical, the necessity for instantaneous TS analysis and prediction becomes increasingly important. This application aims to address the challenges posed by URLLC, helping modern wireless systems to better meet the latency and reliability requirements.

According to some examples, by analyzing patterns, trends, and anomalies in TS data, wireless systems may be able to improve performance, enhance security, and improve user experience. Here are some of the key applications of universal TS in wireless systems:

### (1). Network Performance Monitoring and Traffic Analysis, for Example:

Network Performance Monitoring: By analyzing TS data from network equipment and traffic, wireless systems may proactively identify potential bottlenecks, failures, or areas needing maintenance. This may create a more seamless and efficient network experience for users.

Traffic Analysis: TS data may be able to provide insights into network traffic patterns, helping operators optimize data flow, allocate bandwidth efficiently, and reduce congestion during peak usage times.

### (2). Dynamic Spectrum Allocation and Interference Detection, for Example:

Spectrum Prediction: Using past frequency usage data, TS analysis may be able to predict the best frequency bands to use at any given time, potentially providing more efficient data transmission and reduced interference.

Interference Detection: TS data can help detect patterns that indicate potential interference sources, potentially allowing for timely corrective measures.

### (3). Wireless Sensor Networks and Environmental Monitoring, for Example:

Environmental Monitoring: In areas like agriculture or urban planning, wireless sensors may collect environmental data over time. TS analysis of this data may be able to predict environmental changes, helping in timely decision-making.

Health Monitoring: Wearable sensors in healthcare may collect patient data over time. Analyzing this TS data may be able to predict health trends or deteriorations, potentially enabling proactive medical interventions.

### (4). Optimizing Handovers in Cellular Networks, for Example:

Handover Prediction: As mobile devices move, they may switch between cell towers. TS analysis of past handover data may be able to help predict the optimal times and locations for these switches, which may help to provide uninterrupted connectivity for the user.

### (5). Smart Antenna Systems, for Example:

Beamforming Predictions: Smart antennas may adjust their beam direction for optimal signal quality. Time series data on signal reception may be able to help predict the best beam directions for future transmissions.

### (6). IoT (Internet of Things) Applications, for Example:

Device Interaction Analysis: In a network of interconnected IoT devices, TS analysis may be able to predict how devices will interact based on past interactions, potentially increasing network efficiency.

Optimal Data Transmission Times: For IoT devices transmitting data, TS analysis may be able to predict the best times to send data to help minimize network congestion and provide timely data delivery.

### (7). Adaptive Modulation and Coding, for Example:

By analyzing time series data on channel conditions, wireless systems may be able to predict the optimal modulation and coding schemes to use for future transmissions, potentially improving data integrity and efficient use of the spectrum.

Basically, TS analysis refers to the study of ordered data points collected or recorded at specific time intervals to understand the underlying structure and patterns in the data. The goal may be to extract meaningful statistics, characteristics, and other descriptive features. It often involves tasks like, for example, trend analysis, seasonality detection, and anomaly identification. Among them, TS-based prediction, focuses on forecasting future data points based on the patterns and structures identified during the analysis phase.

Existing TS analysis methods have disadvantages.

Auto-regressive Integrated Moving Average (ARIMA) can model a range of time series data with a combination of autoregressive (AR) and moving average (MA) components. However, it assumes linearity and might not perform well on non-linear data. It also requires the data to be stationary (i.e., properties do not depend on the time at which the series is observed).

Decomposition of Time Series (DTS) breaks down a time series into its constituent elements, such as trend, seasonality, and residuals. However, it is primarily descriptive and might not be suitable for complex forecasting tasks.

Exponential Smoothing (ETS) gives more weight to recent observations, making it adaptive to recent changes. Like ARIMA, it assumes a linear relationship and might struggle with non-linear data.

Long Short-Term Memory (LSTM) Networks are a type of recurrent neural network (RNN) that can model long-term dependencies for complex, non-linear time series data. However, they require significant computational resources and can be challenging to tune. They might also be prone to overfitting without proper regularization.

Prior TS analysis methodologies, may be effective in controlled and static environments but face challenges when applied to the dynamic and complex landscape of modern wireless systems. These prior art methods often rely on assumptions that may not hold in the rapidly changing wireless environment. For instance, they might assume stationarity, whereas wireless systems frequently experience non-stationary phenomena due to user mobility, fluctuating network loads, and changing environmental conditions. Additionally, prior art TS analysis methods might not scale efficiently with the massive volume of data generated by myriad sensors and devices in contemporary wireless networks. The inherent latency in processing this data can lead to outdated predictions (e.g. LSTM), rendering them ineffective for real-time decision-making important in wireless applications. Furthermore, these methods might lack the adaptability to cater to the multi-modality of data sources in wireless, from IoT devices to user equipment.

In many cases, TS analysis relies on Large-scale pre-trained Language Models (LLMs). One example of the structure of LLM is shown in FIG. 1. A LLM may consist of an embedder, an encoding transformer and a decoding transformer. Data or tokens and prompt are fed into the embedder, to get the output of semantic embeddings, then the encoding transformer and the decoding transformer are capable of processing semantic embeddings to generate or predict sentences Wherein the data may be TS data, and the sentences may be the TS analysis results. These models may be trained on large textual datasets, often spanning billions of words. This comprehensive training may equip them with the capability to generate text that is both coherent and contextually relevant.

Central to many LLMs is the Transformer architecture, an innovation that has changed the way models process and generate language. The Transformer's unique self-attention mechanism empowers it to weigh the relevance of different parts of a text, enabling the capture of intricate relationships and dependencies, even over long distances in the text.

The predictive prowess of LLMs is not just confined to generating the next word or phrase in a sentence. Instead, their ability to anticipate and produce sequences makes them valuable tools in diverse applications, from generating human-like responses in chatbots to offering insights in data analysis.

Furthermore, the adaptability of LLMs is showcased in their capacity for transfer learning. They can be fine-tuned on specialized datasets, allowing them to excel in specific tasks while building upon the vast knowledge they've acquired during their initial training.

By processing diverse data forms (e.g. text, images, audio, and more) LLMs may achieve a comprehensive understanding of complex inputs. This capability may allow them to bridge different data domains, offering richer insights and adaptability across a wide range of tasks.

According to some embodiments, TS data refers to a sequence of data points or signals, typically consisting of successive measurements made over a time interval. Examples include stock prices recorded at regular intervals, daily temperatures, and heart rate measurements. Time Series analysis involves extracting meaningful statistics and characteristics from this data, often with the aim of predicting future values.

The integration of TS data with LLMs presents a novel approach to harness the power of both domains. While LLMs are useful in understanding and generating text, TS data offers a structured way to represent changes over time. By combining the two, several advancements can be achieved:

Enhanced Predictive Analysis: LLMs can be trained to analyze Time Series data and make predictions about future data points, leveraging their ability to understand patterns and context.

Data Representation: TS data can be tokenized and represented in a format that LLMs can process, bridging the gap between numerical data and textual understanding.

Versatility: By integrating TS data, LLMs can be applied to a broader range of applications, from financial forecasting to medical diagnostics.

Efficiency: Instead of building specialized models for TS analysis, existing LLMs can be adapted to handle TS tasks, offering a cost-effective and efficient solution.

Modern wireless systems, especially as we transition into the era of 6G, may rely on universal TS analysis. This reliance is evident in several operations, for example but not limited to:

Scheduling: Efficient allocation of resources, such as frequency bands and time slots, may be important for seamless communication. Accurate TS predictions may allow resources to be allocated more optimally, preventing bottlenecks and smoothing data flow.

Power Control: By predicting signal quality and user demands, the system may be able to adjust transmission power levels, resulting in potentially more efficient energy usage and maintaining communication quality.

Latency Reduction: For applications (URLLC) that demand real-time responses, like autonomous driving or telemedicine, reducing latency is important. Reliable TS predictions can preemptively allocate resources, helping to ensure that data packets are transmitted with minimal delays.

Green Communications: With the increasing emphasis on sustainability, “green” communication methods aim to reduce the environmental impact of wireless systems. Accurate TS predictions can optimize system operations to minimize energy consumption, contributing to more eco-friendly communication.

As we look towards 6G and the future of wireless communication, the landscape may be dominated by new sensors and IoT devices. These devices may introduce diverse modalities of TS data, for example but not limited to:

New Sensors and IoT Users: Imagine smart cities where every lamppost, traffic light, and even the road itself is embedded with sensors, continuously transmitting data. Or consider healthcare, where wearable devices monitor vital signs in real-time, providing a continuous stream of health-related TS data.

Future-Proofing: The term “future-proofing” emphasizes the need for systems to be adaptable to future technological advancements and challenges. For instance, as augmented reality (AR) and virtual reality (VR) become mainstream, the demand for high-bandwidth, low-latency communication will skyrocket. Accurate TS predictions will be important to meet these demands without overburdening the network.

Real-time, Multi-modality, multi-source TS Analysis: With the influx of diverse TS data from various sources, wireless systems will need to perform real-time analysis from multiple sources and across multiple modalities. For example, a smart traffic management system might need to analyze and predict TS data from road sensors, weather stations, and vehicle-to-vehicle communication simultaneously to optimize traffic flow.

Universal TS analysis may play an important role in achieving the low-latency and high-reliability benchmarks set by URLLC. By facilitating more informed and timely decisions based on real-time and historical data, the system may be able to meet the demands of URLLC applications.

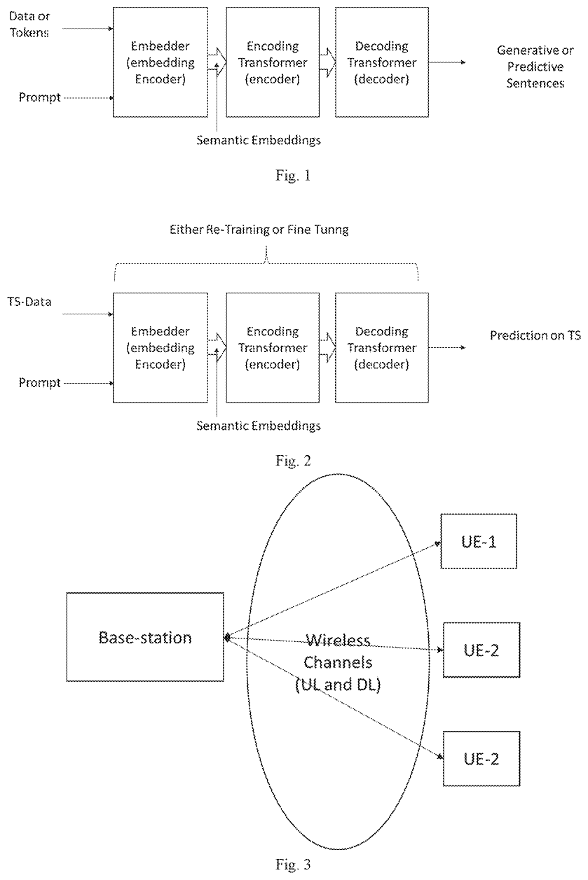

LLMs have demonstrated remarkable prowess in predicting language-related information. However, as shown in FIG. 2, when it comes to handling specific types of time series data, these models often require re-training or fine-tuning. Based on the LLM shown in FIG. 1, the challenge amplifies when encountering a new type of time series. Typically, the entire LLM is retrained or fine-tuned, which means that the embedder, encoding transformer, and decoding transformer all need to be adjusted accordingly. Given the immense size of LLMs, even training or fine-tuning a small fraction of the model can be resource-intensive, both in terms of computational power and time. For instance, adapting an LLM to predict network traffic patterns based on new types of user behavior or emerging technologies can be a daunting task, requiring significant computational resources.

The need for frequent fine-tuning raises pertinent issues, especially in dynamic environments like wireless systems. Two primary concerns emerge:

Speed of Fine-tuning: Wireless systems are ever-evolving, with constant shifts in user behavior, device interactions, and network conditions. For example, the introduction of a new IoT device or a change in data transmission protocols can introduce new time series patterns. The ability to quickly fine-tune an LLM to understand and predict based on these new patterns may become important to maintain system efficiency.

Generalization of LLM for TS analysis: While it's important for an LLM to be specialized enough to accurately predict specific time series patterns, may be equally important for it to be generalized enough to handle a range of similar patterns without needing constant re-training. Consider the scenario of dynamic spectrum allocation in wireless systems. As new communication bands or technologies emerge, the LLM should be adept at predicting optimal frequency allocations without being retrained for each minor variation in the spectrum usage pattern.

Both speed and generalization are important for creating a future-proof wireless system. A system that can swiftly adapt to new patterns while maintaining a broad understanding of related time series may provide greater longevity, scalability, and more consistent performance in the face of evolving wireless technologies and user behaviors.

The size of LLMs may pose deployment challenges, especially in decentralized wireless systems. Typically, these models might only be deployable at base-stations or edge locations due to their computational demands. User Equipments (UEs), which access the LLM via wireless connections, often present diverse TS patterns based on their unique behaviors and functionalities. This diversity necessitates a system that can offer generalized TS analysis. Instead of having multiple specialized models for each UE type, there's a need for a singular, robust TS analysis engine that can analyze a broad range of TS patterns, potentially providing more consistent performance across various UEs. Here are several examples in 6G (future wireless) but not limited:

The demand for real-time data processing and URLLC communication grows. In scenarios where autonomous vehicles communicate with each other and traffic infrastructure in real-time, deploying a bulky LLM directly on these vehicles might be impractical. Instead, they may rely on edge-based LLMs for rapid decision-making, necessitating a generalized time series analysis engine that can cater to diverse vehicular patterns.

The proliferation of IoT devices, from smart home appliances to industrial sensors, may introduce a myriad of unique time series patterns. A smart refrigerator might communicate its energy consumption pattern, while an industrial sensor might relay machinery health data. Having a singular, generalized LLM at an edge location that can predict and analyze all these diverse patterns becomes important.

Heterogeneous Network Environments: Future wireless may see a blend of terrestrial, aerial, and satellite networks. A drone delivering packages might switch between these networks, each with its unique communication pattern. A centralized LLM, capable of understanding and predicting the TS data from these diverse networks, may be important for seamless drone operations.

Dynamic Spectrum Management: As wireless systems evolve, dynamic spectrum sharing may become commonplace, with devices negotiating frequency bands in real-time. An LLM predicting optimal frequency allocations may need to cater to a wide range of device types, from smartphones to IoT sensors, each with its spectrum usage pattern.

While LLMs may hold potential for TS analysis (including prediction) in wireless systems, the challenges of costly re-training, swift adaptation, and maintaining a balance between specialization and generalization are problems that this application aims to address.

In order to solve the previously mentioned problems, including the problems of Speed of Fine-tuning and Generalization of LLM for TS analysis, embodiments of the present application provide a TS analysis method and a TS analysis system. First, described embodiments may help to optimize an existing LLM in the TS analysis engine by replacing a fixed embedded encoder with a customized embedded encoder, e.g., an encoder that is pre-matched to the type of the TS Data, so as to focus on extracting the more important features of the TS data to be input into the LLM, and thus obtaining a more accurate analysis result.

Described solutions are relevant to different scenarios. Different soft prompts may be adopted for different scenarios, which may also be customized according to the type of TS Data, for inputting into the LLM together with the output features of the embedded encoder, and guiding the LLM to make a TS analysis matching the type of data, so that the modified LLM can be better adapted to various different scenarios. In this way, the modified LLM can be adapted to a variety of scenarios and accurately analyze multi-modality or multi-source TS data without the need for repeated training of the modified LLM.

According to some embodiments, the TS analysis engine with the modified LLM may be connected to a base station, such as, for example, integrated in the base station, or connected to the base station via a network or wireless communication. The UEs in the communication system may be connected to the base station, and information may be exchanged between the two, e.g., the UE may send a request to the base station to request the TS analysis engine in the base station to perform the TS analysis required by the UE, and then the base station may send the analysis results to the UE. It is to be understood that in embodiments described herein, the TS analysis may be initiated, for example, by either the UE, or the base station, or network elements deploying the TS analysis engine.

According to some embodiments, the modification of the LLM may include the following two aspects. As a first aspect, the embedding encoder of the LLM is replaced with a customized embedding encoder. For example, different embedding encoders can be used according to different types of TS data to improve the adaptability of the coding features and the TS data. As a second aspect, a soft prompt is added to the input parameters of the LLM, and the soft prompt is able to give specific guidelines to the LLM according to different TS analysis scenarios. A soft prompt may be used to inform the LLM of the type of data that needs to be analyzed, as well as the type of analysis result that needs to be obtained.

According to some embodiments, the base station may select an embedded encoder of the LLM and select the soft prompt. For example, when the base station receives the TS Data sent by the UE, it may also receive the type information of the TS Data sent by the UE, and based on the type information of the TS Data, the base station may select the type information of the TS Data that is compatible with the TS analysis of the LLM. Based on the TS Data type information, the base station may select an embedded encoder and a soft prompt that are suitable for the TS Data. For example, for TS data related to spectrum usage patterns, an encoder tailored to capture frequency bands' usage intensity, duration, and temporal patterns can be selected, and the soft prompt may be determined to be “Given the past spectrum usage, what's the best allocation strategy for the next 10 minutes?”. In other embodiments, the embedded encoder and the soft prompt may be selected by the UE and sent to the base station.

According to some embodiments, the LLM performs TS analysis based on the input, and after outputting the analysis result, the base station may return the analysis result to the UE or send it to other devices that need the analysis result to assist in making necessary decisions during operation.

It is to be understood that the TS analysis method and the TS analysis system described are based on the same inventive concept.

For easing understanding of the embodiments, a basic architecture of the communication system is first described below. According to FIG. 3, the present embodiment describes a wireless communication system comprising a base-station and multiple UEs, and wireless connections among them. The UEs can range from traditional mobile phones and tablets to more specialized devices such as wearable health monitors, IoT sensors, vehicular communication devices, smart home appliances, and industrial automation equipment.

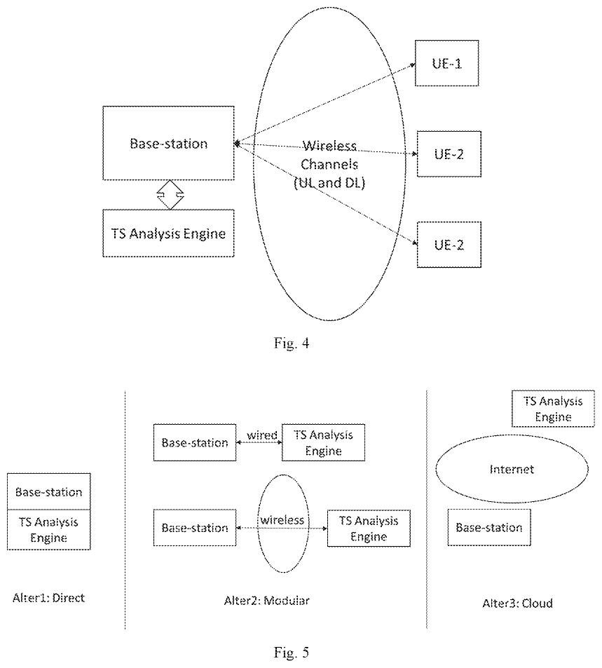

According to some embodiments, described adds a TS analysis engine in a communication system may be referred to as a TS analysis system. An example embodiment is shown in FIG. 4, in which a TS analysis engine is integrated within the base-station is a universal Time Series (TS) analysis engine. This component may be designed to process, analyze, and predict time series data in real-time, catering to the diverse needs of the wireless system.

In the system shown in FIG. 4, the TS analysis engine connects to the base station and can receive multi-source TS data. For example, by the UE sending the TS data to the base station via UL, the TS analysis engine in the base station can analyze all of the received multi-source TS data and obtain the analysis results. Then the base station may send the analysis results to UE via DL. Other devices, such as the UE, may access the TS analysis engine in the base station. In one embodiment, the UE may understand a surrounding environment of the UE, such as a network condition around the UE, based on the analysis results.

Depending on the example, a variety of integration methods may exist for the TS analysis engine. Referring to FIG. 5, the integration methods may include Direct Integration, Modular Integration, and Cloud Integration. Some integration methods are further described below in conjunction with FIG. 5.
(1). Alternative-1 Direct Integration: Here, the universal TS analysis engine is incorporated within the core infrastructure of the base-station. This may provide a direct and efficient communication pathway with other functionalities and components of the base-station. For example, the TS analysis engine can directly read the data in the base-station, such as the TS analysis request sent by the UE and the related data. Accordingly, the base-station can directly read the analysis results generated by the TS analysis engine and send the analysis results to the UE.
(2). Alternative-2 Modular Integration: In this approach, the universal TS analysis engine includes distinct modules. Information such as TS data or TS analysis result can be transferred between these modules. These modules can be, for Example:

Wired Integration: The modules are physically connected to the base-station using wired interfaces, which may provide a stable and high-speed connection.

Wireless Integration: The modules communicate with the base-station wirelessly, offering flexibility in placement and potential for remote updates or modifications, including edge devices.
(3). Alternative-3 Cloud Integration: The functionalities of the universal TS analysis engine are hosted on a cloud platform. The base-station accesses these services as and when required, helping to provide scalability, flexibility, and the potential for remote updates. As an example, base-station may upload the TS data to TS analysis engine via internet, based on which the TS analysis engine can generate TS analysis result.

In summary, a TS analysis engine can integrate multiple sources of real-time data and signals, analyze them, and obtain results in multiple areas for use in various devices. The functionality about dealing with different data types and corresponding analysis mentioned above will be described in detail in the paragraphs describing the system functions below.

In order to realize a TS analysis engine capable of processing multi-source TS data and performing various classes of TS analysis, the present application modifies the present LLM and soft prompt. In the TS analysis method provided in the embodiments of the present application, the LLM and the soft prompt with greater versatility are used, for example, the soft prompt is used to provide different guidance to the LLM according to different TS data scenarios, so that the LLM can be adapted to a wider range of TS data analysis scenarios.

In the following, the LLM and soft prompt in this application are introduced.

The LLM operates on a transformer architecture. It consists of an encoder and a decoder. Within the encoder is an embedder that is responsible for converting tokens into semantic embeddings. These tokens can be derived from the TS data series (sequences of data points or signals) received either from the UEs via wireless uplink or directly from the base-station. Additionally, prompts are used to guide the LLM in its processing.

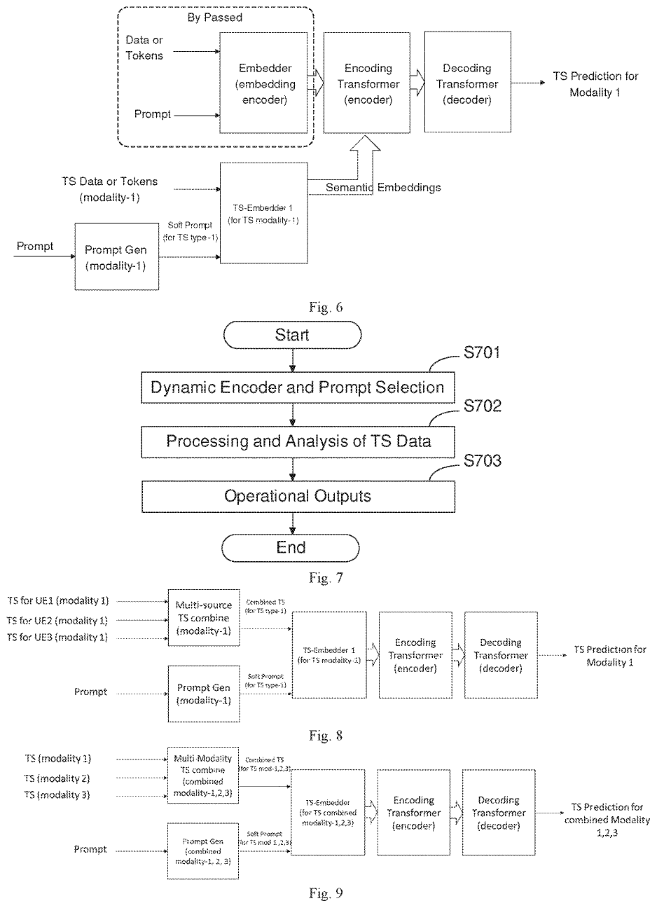

According to FIG. 6, the LLM's original embedding encoder is replaced with a new, specialized or customized version. This new encoder is tailored to handle a diverse range of input TS data, helping to ensure that the generated embeddings are both accurate and contextually relevant.

A normal prompt is a predefined and fixed set of words or phrases that guide a model's response. It acts as an instruction or a question to the model. It's typically used at the beginning of a model's input to set the context or to ask a specific question. Normal prompts are rigid. Once set, they don't change during the model's operation unless manually altered by the user.

A soft prompt, unlike a normal prompt, is not fixed. It is a set of learnable parameters that can be optimized during the model's operation to improve its performance on specific tasks. Soft prompts are used to fine-tune a model's response without retraining the entire model. They act as adaptable guides that can be adjusted based on the model's feedback to achieve desired outputs. Soft prompts are dynamic. They can be updated and optimized based on the task at hand, making them more adaptable than normal prompts.

In LLMs for TS analysis, the relationship between a customized embedding encoder and its associated soft prompts may be important. The customized embedding encoder is tailored to transform a specific type of TS data into a semantic representation that the LLM can understand. This encoder may help ensure that the unique characteristics and nuances of the TS data are captured effectively. On the other hand, soft prompts may act as dynamic guiding signals for the LLM. Instead of being fixed instructions, these prompts are sets of learnable parameters that can be optimized to achieve desired outputs for the given TS data. Together, the customized embedding encoder sets the context by converting the TS data into a suitable format, while the soft prompts guide the LLM's response to help provide more accurate and relevant analysis and predictions. This synergy between the encoder and the soft prompts allows for a more adaptable and precise approach to TS analysis using LLMs, without the need for extensive retraining of the model.

TS analysis can be applied to multiple scenarios, and for each scenario, the customized embedding encoder and soft prompt can be targeted to fit the needs of that scenario.

Several examples are introduced below but not limited:

### (1). Dynamic Spectrum Allocation:

Customized Embedding Encoder: For TS data related to spectrum usage patterns, the encoder might be tailored to capture frequency bands' usage intensity, duration, and temporal patterns.

Soft Prompt: The soft prompt could guide the LLM to predict future spectrum demands, suggesting optimal allocation strategies. For instance, the soft prompt might be optimized to ask, “Given the past spectrum usage, what's the best allocation strategy for the next 10 minutes?”

### (2). Interference Detection:

Customized Embedding Encoder: In scenarios where TS data represents signal strengths and noise levels, the encoder may be designed to emphasize sudden spikes or drops, which might indicate interference.

Soft Prompt: The soft prompt could be tailored to guide the LLM to identify potential sources of interference or suggest mitigation strategies. It might be optimized to inquire, “Based on the signal patterns, are there potential interference sources at next TTIs?”

### (3). Optimizing Handovers in Cellular Networks:

Customized Embedding Encoder: For TS data detailing a mobile device's movement and signal strength from various base stations, the encoder could focus on capturing patterns of movement and signal degradation.

Soft Prompt: The soft prompt might guide the LLM to predict when a handover might be necessary and to which base station. It could be optimized to question, “Given the device's trajectory and signal strengths, when and where should the next handover occur at the next 10 TTIs?”

### (4). Beamforming Predictions in 5G/6G Networks:

Customized Embedding Encoder: When TS data represents the angles of arrival and departure of signals between devices and base stations, the encoder could be tailored to emphasize these angular patterns.

Soft Prompt: The soft prompt could guide the LLM to suggest optimal beamforming strategies to enhance signal strength and reduce interference. It might be optimized to ask, “Based on the angular data, how should the beamforming be adjusted for optimal performance?”

In the above embodiments, the soft prompt may be based on information on the TS data type and information on the TS analysis requirements. Thus, the soft prompt may not only direct the LLM to the TS data type to be processed, but also provide the analysis requirement to the LLM.

It should be noted that the above soft prompt is only an example in the above scenario, and in other scenarios, a soft prompt can be optimized for other interrogation statements. For different TS analysis scenarios, the soft prompt is obtained based on the nature of different types of TS data and different analysis requirements for TS data, and provides guidance to the LLM, so that the LLM can obtain accurate analysis results under the guidance of the soft prompt.

To summarize, depending on the specific characteristics of the input TS data, an appropriate embedding encoder is chosen to replace the LLM's default encoder. Alongside this, specific soft-prompts are selected. These soft-prompts may act as guiding signals for the LLM, which may help to ensure that the analysis and prediction tasks are tailored to the specific nature of the TS data.

Based on the LLM and soft prompt described above, the selected TS data, along with the selected soft-prompts, are fed into the modified LLM by the TS analysis method provided in this application. The LLM, with its vast training and the guidance from the soft-prompts, performs the TS analysis tasks. With its vast training and the guidance from the soft-prompts, performs the TS analysis tasks.

According to some embodiments, the described TS analysis method may operate with the base station as the main initiator or with the UE as the main initiator. Referring to FIG. 7, regardless of whether the subject of execution of the TS analysis method is a base station or a UE, an exemplary process for TS analysis includes:

### S701: Dynamic Encoder and Prompt Selection:

Depending on the specific characteristics of the input TS data, an appropriate embedding encoder is chosen to replace the LLM's default encoder.

For example, the TS data may be categorized into a plurality of types, wherein the plurality of types includes at least a first type and a second type. According to a pre-setting, the first type is applicable to the first embedded encoder and the second type is applicable to the second embedding encoder. In the case where the input TS data is detected to be of the first type, the first embedding encoder may be used to replace the default encoder of the LLM; or, in the case where the input TS data is detected to be of the second type, the second embedding encoder may be used to replace the default encoder of the LLM.

In some embodiments, the first type may indicate the TS data related to the signal strength of the base station, and correspondingly, the first embedding encoder may be an encoder for focusing on capturing features such as signal attenuation, signal enhancement, and the like. It should be noted that the type of TS data may also be other types, and the customized embedding encoder may also be an encoder for other types of TS data, which is not limited by the present embodiments.

Alongside this, specific soft-prompts are selected. These soft-prompts act as guiding signals for the LLM, which may help to ensure that the analysis and prediction tasks are tailored to the specific nature of the TS data.

According to some embodiments, in the case where the input TS data includes a preset type, the soft prompt may be the content corresponding to the preset type. For example, if the type of the input TS data includes two types. For example, a first type, signal strength data of the base station, and a second type, location data of the UE. Then it may be determined that the need for the TS analysis is to determine the base station to which the UE is to be handed over and the time of the handover, and the soft prompt can be “Given the device's trajectory and signal strengths, when and where should the next handover occur at the next 10 TTIs?” corresponding to the preset type and signal strengths.

In some embodiments, the soft prompt may be optimized based on a type of TS data. In other embodiments, the soft prompt may also be determined based on the type of TS data, as well as demand information related to the TS data. For example, the base station may detect demand information, or the UE may send indication information related to the soft prompt when sending TS data to the base station, such as the information of “when are the two subsequent switching times”, at which time it may be determined that the soft prompt may be “Given the device's trajectory and signal strengths, when and where”, and the soft prompt may be “Given the device's trajectory and signal strengths, when and where”. Given the device's trajectory and signal strengths, when and where should the next two handover occur at the next 10 TTIs? It should be noted that the soft prompt may contain other contents according to different types of TS data and different requirements, and the present application does not restrict this.

According to some embodiments, customized embedding encoder can support multi-source and multi-modality:

From implementation consideration, to achieve the integration of multi-source and multi-modality data streams, a customized embedding encoder and corresponding soft prompts are prerequisites. These components may help ensure that the LLM can more effectively process the integrated data streams without the need for extensive retraining or fine-tuning.

Notably, the processes of auto-encoder and contrastive learning, which aid in obtaining these customized components, are efficient. They may utilize less than 0.05% of resource to fine tune the LLM, potentially providing a lightweight yet effective solution. This foundational capability paves the way for the subsequent benefits and applications as followings:

### Multi-Source TS Integration:

According to embodiments shown in FIG. 8, customized embedding encoder can support multi-source TS integration.

LLMs can integrate several TS data streams originating from different UEs. This amalgamation may help ensure a more comprehensive view of the network's state, which may enhance the accuracy of predictions and analyses. Example: Consider a scenario where TS data from a number of UEs, detailing their DL Channel State Information (CSI) sequences over a specific period of time, is integrated. This collective data stream can provide insights into potential handovers, interference zones, or optimal data transmission times for the group of UEs within that channel environment.

### Multi-Modality TS Integration:

According to embodiments shown in FIG. 9, customized embedding encoder can support multi-modality TS integration.

Beyond just multiple sources, LLMs can also embed different modalities of the TS data. This capability may help provide a richer context and capture the nuances of the wireless environment. For example, in the case of a base-station equipped with mmWave technology capturing point-cloud sensing TS data, spatial data may be integrated with CSI sequences from multiple UEs and SRS sequence from the base-station. Such a combination can offer insights into optimal beamforming strategies, interference mitigation, or even user density in a particular zone.

### S702: Processing and Analysis of TS Data:

The chosen TS data, along with the selected soft-prompts, are fed into the modified LLM. The LLM, with its vast training and the guidance from the soft-prompts, performs the TS analysis tasks.

According to some embodiments, the LLM may be trained based on a training set. In one example, the training set may include TS data for training, soft prompts for training, and, reference analysis results corresponding to the TS data and soft prompts described above. The LLM may be trained in multiple rounds to obtain a trained LLM, wherein the output of the trained LLM has less deviation from the reference analysis results. It should be noted that the above embodiment is only an example of training an LLM, and the present application does not limit the method of training an LLM.

### S703: Operational Outputs:

As an example, the TS data are fed into the modified LLM, and the modified LLM can output the TS analysis result, as an operational outputs.

According to some embodiments, for base-station operations, when the analysis tasks cater to base-station-centric operations, the outputs are channeled to the relevant downstream functionalities. This can encompass a variety of tasks, from scheduling and performance optimization to interference management and more. In the realm of URLLC, where latency is an important factor, the universal TS analysis engine may be important. They aid in real-time traffic management, dynamic resource allocation, and proactive interference management, help meet the latency and reliability requirements of URLLC.

According to some embodiments, for UE-centric operations, if the TS analysis is tailored for the UEs, the results are transmitted to the respective UEs using wireless downlink channels. This may help in providing the UEs with insights that may help optimize their individual operations. From the perspective of UEs, insights from the universal TS analysis engine may be important, especially in URLLC scenarios. They may enable UEs to manage their operations efficiently, helping to provide more timely data transmission and reception, which is important for applications demanding ultra-reliability and low latency. For example, in the above embodiment of the TS analysis result for when to switch base stations, the analysis result including the time of switching base stations may instruct the UE to perform base station switching to switch to a specified base station at a specified time.

By executing a TS analysis method provided in embodiments of the present application, different types of TS data, i.e., multi-modality TS data, can be analyzed by the modified LLM in the TS analysis engine, and the customized soft prompt, and the corresponding analysis results can be obtained. The analysis results can help UEs and other devices to make better decisions during operation. Meanwhile, by integrating multi-source TS data, the analysis results can be more comprehensive.

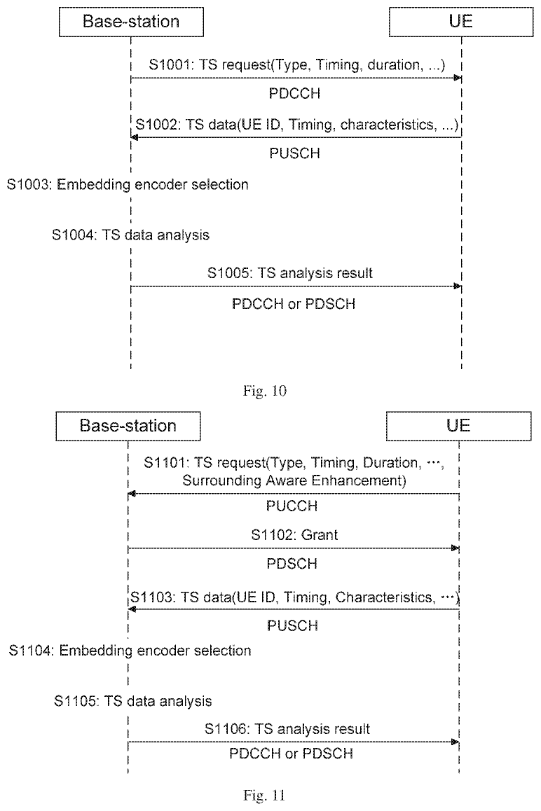

According to some embodiments, when the base station needs to collect TS data from at least one UE, it sends a request to the UE, analyzes the data based on the collected data, and finally returns the analysis results to the UE. In this embodiment, as shown in FIG. 10, the TS analysis method includes:

### S1001: Base-Station can Send a TS Request to UEs:

In cases where the base-station needs to perform TS analysis based on the data from the UEs, the base-station may send a TS request to the UEs to instruct the UEs to provide the base-station with the data required for the TS analysis.

Through PDCCH, the base-station sends a TS request to the UEs. According to some embodiments, this request may specify:

Type of TS Data: Indicating the kind of time series data required, such as CSI, signal strength, time advancement, RSSI, or user activity patterns.

Timing Information: Specifying when the UEs should collect and send the TS data, to help with synchronization.

Duration: Indicating the period over which the TS data should be collected.

### S1002: UEs Send TS Data to Base-Station:

As UEs receive the TS request, UEs may send TS data to base-station.

UEs, upon receiving the TS request, start collecting the specified data, which they send to base-station as feedback. Once collected, they transmit this data to the base-station through PUSCH. The feedback may include:

UE ID: A unique identifier for each UE, helping the base-station to differentiate between data sources.

Timing Information: Timestamps indicating when each data point was collected.

Characteristics: Specific attributes or metrics of the TS data, such as signal quality, modulation schemes used, or interference levels.

Additional Metadata: Other relevant information that can aid in the analysis, like battery levels, active applications, or network conditions.

### S1003: Base-Station's Embedding Encoder Selection:

Based on the specific characteristics of the received TS data, the base-station selects an appropriate embedding encoder to replace the default encoder of the LLM. Concurrently, specific soft-prompts tailored to the nature of the TS data are chosen. These soft-prompts guide the LLM's analysis and prediction tasks. Optionally, the base-station might decide to combine TS data from multiple UEs using a single embedding encoder or even integrate multi-source, multi-modality TS data into one encoder.

According to some embodiments, if the TS data includes a plurality of types, a plurality of embedding encoders may be selected based on the plurality of types, and each embedding encoder corresponds one-to-one with each type. For example, the plurality of types includes a first type and a second type, and according to a pre-setting, the first type is applicable to the first embedding encoder and the second type is applicable to the second embedding encoder. It is understood that the TS data of the first type is input into the first embedding encoder to obtain a first coding feature, and the TS data of the second type is input into the second embedding encoder to obtain a second coding feature, wherein the first coding feature and the second coding feature may be jointly used as inputs to the LLM.

### S1004: TS Data Analysis at Base-Station:

The selected TS data, combined with the chosen soft-prompts, are input into the modified LLM. Leveraging its extensive training and the guidance from the soft-prompts, the LLM undertakes the TS analysis and prediction tasks, processing the data to derive meaningful insights and forecasts.

According to some embodiments, since the TS data is already well transformed into coding features, and the soft prompt can provide guidance to the LLM on the type of data and the goal of the analysis, the LLM is equipped to process the TS data to obtain meaningful results without retraining.

### S1005: Channeling TS Analysis Result for Base-Station Operations:

If the TS analysis tasks are oriented towards base-station-centric operations, the base-station routes the LLM's outputs to the pertinent downstream functionalities. This can encompass a myriad of operations, ranging from resource scheduling, performance optimization, interference management, to other network optimization tasks.

In the above embodiment described in conjunction with FIG. 10, the TS analysis may be initiated by the base-station, which requests data from the UEs for TS analysis engine operation. And base-station can send the TS analysis result to any downstream device, such as an UE, as a result, efficient TS analysis can be realized.

According to some embodiments, when the UE has a need for TS analysis, it sends a request to the base station, and after the base station grants permission, the UE can send TS data to the base station, and finally the base station returns the analysis results to the UE. Among this embodiment, as shown in FIG. 11, the TS analysis method includes:

### S1101: UE's TS Analysis Request to Base-Station:

In cases where a UE needs a TS analysis result, the UE may send a TS request to the base-station to ask for base-station's grant.

UEs, sensing a need for TS analysis or prediction, spontaneously send a request to the base-station via PUCCH. This request may specify:

Type of TS Data: Indicating the kind of time series data for which analysis or prediction is sought, such as CSI, signal strength, or user activity patterns.

Timing Information: Specifying when the UEs intend to collect and send the TS data. Duration: Indicating the period over which the TS data has been or will be collected.

Surrounding Aware Enhancement: A flag or parameter indicating if the UE desires enhanced analysis that takes into account data from neighboring UEs or other sources.

According to some embodiments, the base station may determine the soft prompt based on the parameters described above, for example, the type information in the soft prompt may be determined based on the type of TS data contained in the request, or the timing information or duration in the request may be determined based on the timing information or duration in the soft prompt. For example, the timing information in the soft prompt may be determined based on the Timing Information or Duration in the request.

### S1102: Base-Station's Grant and Notification:

Upon receiving the request, the base-station evaluates its feasibility and, if deemed appropriate, grants the request. The grant, along with any additional instructions or parameters, is then communicated to the requesting UE via PDCCH.

### S1103: UE's TS Data Transmission to Base-Station:

Following the grant, the UE collects and transmits the specified TS data to the base-station through PUSCH. This data may include:

UE ID: A unique identifier for the UE.

Timing Information: Timestamps indicating when each data point was collected.

Duration: The span over which the data was gathered.

Characteristics: Specific attributes or metrics of the TS data, such as signal quality, modulation schemes used, or interference levels.

Additional Metadata: Other pertinent information that can aid in the analysis.

According to some embodiments, the Additional Metadata may contain information about the purpose of the analysis, i.e., information about the type of data that the UE needs to know about the results of the analysis. For example, information about the time of switching base stations.

### S1104: Base-Station's Embedding Encoder Selection:

Based on the characteristics of the received TS data, the base-station selects an appropriate embedding encoder to replace the LLM's default encoder. Concurrently, specific soft-prompts tailored to the nature of the TS data are chosen. If the UE's request indicated a need for surrounding aware enhancement, the base-station might opt to integrate TS data from multiple UEs or even combine multi-modality data into one encoder.

### S1105: TS's Data Analysis at Base-Station:

As the embedding encoder is selected, TS data analysis can be performed at base-station.

The selected TS data, combined with the chosen soft-prompts, are input into the modified LLM. The LLM, leveraging its extensive training and the guidance from the soft-prompts, undertakes the TS analysis and prediction tasks, processing the data to derive actionable insights and forecasts.

### S1106: Base-Station's Transmission of Results to UEs:

Once the analysis tasks are completed, the base-station transmits the results to the respective UEs via PDSCH. These results may be tailored to each UE's specific request and data, helping the UEs to optimize their operations, provide more efficient and seamless communication within the wireless network.

By adhering to this structured procedure, the base-station and UEs may be able to more effectively collaborate, helping UEs' spontaneous needs for TS analysis to be met more promptly and accurately.

In a dynamic wireless communication environment, the base-station-centric and UE-centric procedures for time series data analysis may be integrated and operated concurrently. The base-station, while proactively initiating requests for TS data to help optimize network-wide operations, can simultaneously cater to individual UE-initiated requests for specific TS analysis. This hybrid approach helps the base-station to maintain network performance and resource allocation, while also addressing the needs and preferences of individual UEs. Such a synergistic operation, facilitated by the adaptability of the LLM and the flexibility of the wireless physical channels and control messages, may offer a robust and efficient mechanism to maximize the benefits of TS analysis and prediction in a diverse wireless ecosystem.

In the embodiment described above in conjunction with FIG. 11, a TS analysis process may be initiated by the UE when there is a demand for TS analysis by the UE, so as to satisfy the demand for analyzing data by the downstream device. In other embodiments, the TS analysis request may also be sent to the base-station by a device other than the UE, such as a device such as a car, which may then send the relevant data required for the TS analysis to the base-station and receive the corresponding TS analysis results.

Building upon the integrated framework of the base-station-centric and UE-centric procedures, it is important that the mixed procedure exhibits a high degree of flexibility. This adaptability may help the system to dynamically prioritize and adjust its operations based on real-time network conditions, UE demands, and other external factors. Whether it's responding to a surge in UE-initiated requests or preemptively optimizing network resources in anticipation of high traffic, the procedure's flexibility may facilitate a more harmonious balance between centralized network optimization and individual UE satisfaction. Such a malleable system design may enhance the overall efficiency and responsiveness of the wireless communication environment and may position it to adapt to future advancements and challenges in the ever-evolving wireless domain.

Enhanced Predictive Analysis: The integration of LLMs with TS data offers a novel approach to harness the predictive prowess of both domains. LLMs, with their extensive training and understanding of patterns, can be trained to analyze TS data and make predictions about future data points. This synergy may enhance the accuracy and reliability of predictions, especially in dynamic environments like wireless systems.

Versatility in Applications: By incorporating TS data, LLMs can be extended to a broader range of applications. This includes, but is not limited to, financial forecasting, medical diagnostics, network performance monitoring, and traffic analysis. Such versatility helps the system to remain adaptable and relevant across diverse scenarios and use cases.

Efficiency and Cost-effectiveness: Instead of building specialized models for each TS analysis task, existing LLMs can be adapted to handle multiple TS tasks. This approach offers a cost-effective solution, eliminating the need for developing and maintaining multiple models. It may also help the system to remain scalable and handle large volumes of data without significant overheads.

Real-time Multi-modality TS Analysis: The embodiment emphasizes the importance of analyzing and predicting data from various sources in real-time. For instance, a smart traffic management system might need to process data from road sensors, weather stations, and vehicle-to-vehicle communication simultaneously. The ability to handle multi-modality TS data may help the system to remain responsive and make informed decisions based on comprehensive insights.

Future-proofing and Scalability: As wireless technology evolves, the landscape may be dominated by new sensors and IoT devices, introducing diverse modalities of TS data. This embodiment may help to ensure that the system is future-proofed, meaning it is designed to be adaptable to future technological advancements and challenges. Whether it's the introduction of new communication bands, technologies, or user behaviors, the system is equipped to adapt and provide more consistent performance.

Addressing Challenges of Traditional TS Methods: Traditional TS analysis methodologies often face challenges when applied to dynamic environments like wireless systems. The embodiment addresses these challenges by leveraging the strengths of LLMs. It helps the system to handle non-stationary phenomena, scale efficiently with massive data volumes, and remain adaptable to the multi-modality of data sources.

Surrounding-aware Enhancement for Individual UEs: From the perspective of a single UE, the embodiment's capability for surrounding-aware enhancements is advantageous. When a UE sends its TS data to the base-station, the integrated TS analyzer and predictor can combine this data with information from other sources, helping to provide a richer context. This means that the analysis and predictions tailored for that specific UE can take into account its own data and the broader environmental context in which it operates. As a result, the UE may benefit from predictions that are more accurate and relevant to its immediate surroundings. Whether it's anticipating changes in signal strength based on nearby obstacles or adjusting for potential interference from neighboring devices, the UE may be able to operate more efficiently and reliably, thanks to the surrounding-aware insights provided by the system.

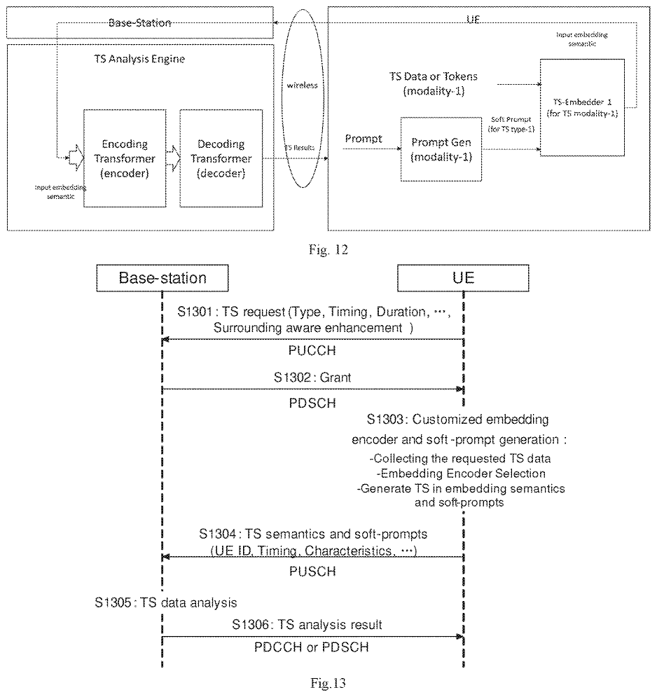

Building on the embodiment presented above, another embodiment will be presented below. The embodiment to be described below shifts the focus towards a more UE-centric approach. Referring to FIG. 12, the UE takes a proactive role in the TS analysis process by generating its own embedding semantics and soft-prompts, which are then sent to the base-station for further processing with the modified LLM.

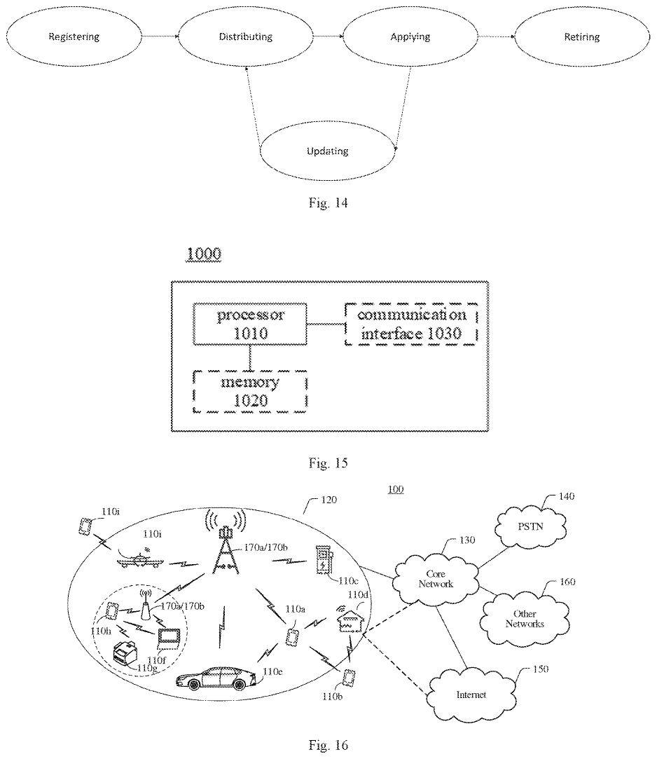

Referring to FIG. 13, in this embodiment, the process of TS analysis includes:

### S1301: UE-Initiated TS Request:

In cases where a UE needs a TS analysis result, the UE may send a TS request to the base-station to ask for base-station's grant.

Utilizing physical channels and control messages, a UE may spontaneously send a TS analysis or prediction request to the base-station. This request may include details such as the type of TS data, desired duration for prediction, and any specific surrounding-aware enhancements. Physical Channel may be PUCCH. Control Message may be radio resource control (RRC) message containing the TS analysis or prediction request details.

### S1302: Base-Station's Grant and Notification:

Upon receiving the request, the base-station sends a grant message, notifying the UE to proceed with the data transmission. Physical Channel may be PDCCH. Control Message may be DCI indicating the grant for the UE to proceed with data transmission.

### S1303: UE's Customized Embedding Encoder and Soft-Prompt Generation:

The UE, equipped with the capability to generate its own embedding encoder, processes its TS data to create semantic embeddings. This “TS in semantic embedding” provides a richer representation of the time series data, capturing intricate patterns and relationships. Simultaneously, it generates a soft-prompt tailored to its specific needs. These soft-prompts act as guiding signals, so that the analysis and prediction tasks may be tailored to the specific nature of the UE's TS data. This step primarily involves internal processing within the UE and doesn't directly utilize a specific physical channel or control message.

For example, when UE needs the information on the time of handover, and the TS data include a first type, signal strength data of the base station, and a second type, location data of the UE, the soft prompt and be determined as “Given the device's trajectory and signal strengths, when and where should the next handover occur at the next 10 TTIs?” in this scenario. At the same time, UE can generate or choose the embedding encoder that fits the first type and the second type of the TS data, by which UE can generate the semantic embeddings. It can be understood that in this embodiment, the base station does not need to make a decision, and since the UE is the party making the request, the UE will know more about the required TS analysis than the base station, and having the UE decide on the selection of the soft prompt and the embedding encoder can result in a higher accuracy of the TS analysis.

### S1304: Transmission of TS Semantic and Soft-Prompts to Base-Station:

The UE then transmits the generated semantic embeddings and soft-prompts to the base-station using uplink channels. This data includes the UE ID, timing information, duration, characteristics, and other relevant details. Physical Channel may be PUSCH. Control Message may be UCI (Uplink Control Information) accompanying the data, providing details like UE ID, timing information, and other relevant metadata.

S1305: Base-Station Processing TS Data Analysis with Modified LLM:

Upon receiving the data from the UE, the base-station inputs the semantic embeddings and soft-prompts into the modified LLM, bypassing the original embedding encoder. The LLM, guided by the soft-prompts and enriched by the UE-generated embeddings, performs the TS analysis tasks. This step involves internal processing within the base-station and doesn't directly utilize a specific physical channel or control message.

### S1306: TS Analysis Result Transmission to UE:

Once the analysis tasks are completed, the base-station transmits the results back to the respective UE using downlink channels so that the UE receives insights tailored to its specific requirements. Physical Channel may be PDSCH (Physical Downlink Shared Channel). Control Message may be DCI (Downlink Control Information) indicating the scheduling of the results for the UE.

While the primary focus of this embodiment is on UE-centric operations, it's worth noting that the procedures detailed in the embodiment described with FIG. 10 or FIG. 11, especially those related to base-station-centric operations, can be integrated. This helps provide a flexible and adaptive system that can cater to both base-station and UE-specific needs. Depending on the specific operation, various channels like PDCCH, PDSCH, PUCCH, and PUSCH can be utilized, accompanied by their respective control messages like DCI and UCI.

With the process of the embodiments described, the following effects can be realized.

Efficient Data Transmission with Semantic Embeddings: One of the standout advantages of Embodiment 3 is the transmission of TS in semantic embeddings from the UE to the base-station. Instead of sending raw TS data, which can be voluminous and bandwidth-consuming, the UEs transmit compact semantic embeddings. This reduces the data load on uplink channels and allows the most salient features of the TS data to be captured and communicated.

Enhanced Data Privacy: By transmitting semantic embeddings rather than raw data, the UEs inherently add a layer of data privacy. The original raw TS data remains within the UE, and only the processed embeddings, which are more abstract representations, are sent out.

Reduced Latency: Transmitting compact semantic embeddings can lead to faster data transmission times, reducing the overall latency in the system. This is particularly beneficial for real-time applications in wireless systems where timely data analysis and prediction are important.

Adaptive and Customized Analysis: Since the UEs generate their own embedding encoders and soft-prompts based on their specific needs and characteristics, the analysis and prediction tasks become highly tailored so that the insights derived are more relevant and actionable for each individual UE.

Resource Efficiency at the Base-Station: The base-station, by receiving pre-processed semantic embeddings, can bypass the initial stages of data processing. This leads to more efficient utilization of computational resources at the base-station, allowing it to serve more UEs simultaneously.

Scalability and Flexibility: The approach of Embodiment 3 is inherently scalable. As more UEs with diverse TS data types join the network, the system can easily accommodate them without significant changes. The UEs generate and transmit their unique semantic embeddings, to help provide a more seamless integration into the existing framework.

Enhanced Predictive Capabilities: With UEs transmitting TS in semantic embeddings, the base-station's LLM can focus on the core task of analysis and prediction. This, combined with the tailored soft-prompts, may provide more accurate and insightful predictions, which may enhance the overall system performance.

In embodiments of the present application, a TS analysis system with multiple TS analysis capabilities has been implemented. It is understood that the TS analysis functionality may include base-station functionality and UE functionality, respectively.

Several embodiments of functionality at base-station operations are described below.

(1). Elementary Operations: to Predict Time-varying channel Environment:

Multi-source and multi-modality sensing UEs: UEs regularly feedback channel state information estimated from downlink (DL) transmissions. Additionally, the base-station measures sounding signals from UL to gain insights into the channel's current state. These channel measurements may consist of TS data. Certain UEs equipped with advanced sensors monitor and feedback real-time environmental data, such as 3D point clouds, atmospheric conditions, physical obstructions, and other TS data or signals that might influence the wireless channel.

Multi-source and multi-Modality TS Data Integration: By integrating multiple sources of real-time data and signals, the TS analyzer engine can generate a comprehensive and accurate prediction of the time varying channel environment.

(2). Enhanced Operations through Predicted Channel Environment (Elementary Operations), for Examples:

Scheduling: Efficiently allocate resources like frequency bands, time slots, and power levels, for smoother data flow and reduced bottlenecks.

Performance Optimization: Adjust operations based on historical and real-time data to enhance system performance, including power level adjustments and handover management.

Load Balancing: Distribute traffic evenly across resources, preventing overloads, especially during high-traffic periods.

Energy Management: Optimize energy consumption by transitioning to energy-saving modes during predicted low-activity periods.

Interference Management: Proactively adjust operations to counteract anticipated interference sources for more consistent service.

Adaptive Modulation and Coding Scheme: Modify modulation and coding schemes based on predicted channel conditions to improve data rates.

Predictive Maintenance: Identify potential hardware issues in advance, allowing for timely maintenance and reducing unexpected downtimes.

Security Enhancements: Detect potential security threats by analyzing data traffic patterns, taking preventive actions as needed.

Dynamic Spectrum Allocation: Allocate spectrum resources efficiently based on predicted usage patterns.

User Behavior Analysis: Tailor services to individual user needs by understanding and predicting user behavior.

Enhanced Operations at the base-station above are exemplary. Enhanced operations are designed to be open-ended, allowing for diverse individual implementations that hold potential for significant commercial benefits. Central to realizing these benefits is the presence of a universal TS analysis engine capable of conducting real-time TS analysis across multiple sources and modalities of TS data.

Several implementations of functionality at UE operations are described below.

### (1). Elementary Operations: UE Access to the Universal TS Analysis Engine Via Wireless System, for Example:

Bidirectional Data Flow: The integration may help to provide a smooth bidirectional flow of data. UEs can send their time series (TS) data to the base-station. In return, the base-station processes this data through the universal TS analysis engine and sends back the relevant analysis and predictions to the UEs.

Real-time Processing: As UEs transmit their TS data, the base-station is equipped to handle and process this data in real-time. This helps to ensure that UEs receive timely and relevant feedback, allowing them to act on the predictions without delay.

Optimized Data Transmission: The system is designed to handle the transmission of TS data efficiently. Compression techniques and optimized transmission protocols may help to ensure that the data sent from UEs to the base-station, and vice versa, is done with minimal latency and resource usage.

Adaptive Feedback: Depending on the nature of the TS data sent by the UE, the base-station's feedback can be adaptive. For instance, if a UE sends data indicating sudden changes in its environment, the feedback from the base-station might prioritize immediate actions or adjustments the UE should consider.

### Tailored Predictions:

Personalized Insights: Depending on the type and role of the UE, the universal TS analysis engine can provide tailored insights. For instance, a smartwatch might receive predictions related to user activity patterns, while an IoT sensor in a factory might get forecasts about equipment performance.

Surrounding Awareness Enhancement: With access to the universal TS analysis engine, a single UE can gain a comprehensive understanding of its surrounding environment. This could mean a smartphone understanding the network conditions of nearby devices, or a vehicle's communication device predicting traffic patterns based on nearby vehicular data transmissions.

### (2). Enhanced Operations: Through the Access to the Universal TS Analysis Engine Via Wireless, for Examples:

Enhanced Inter-device Communication: A UE, with its newfound understanding of its surroundings, may be able to communicate more effectively with other devices. For instance, a smart home device may adjust its operations based on the predicted behavior of other devices in the home which may create more harmonious inter-device interactions.

Proactive Adaptation: UEs may proactively adapt to predicted changes in their environment. A drone, for instance, might adjust its flight path based on predicted wind patterns, or a smart thermostat might adjust room temperatures based on predicted changes in outdoor weather.

Efficient Data Usage: By understanding and predicting network conditions, UEs may better optimize their data usage, allowing tasks to be carried out when the network is least congested or when data rates are lower.

Safe Data Transmission: UEs may leverage the TS prediction to identify optimal times for transmitting sensitive data, allowing it to be sent when the network is most secure. Additionally, the system may anonymize user data used for predictions, preserving user privacy.

Shared Insights: Multiple UEs can benefit from shared insights. For instance, if one device detects a change in network conditions, this information can be used to adjust predictions for other devices in the vicinity, allowing for a more cohesive network experience.

Similar to the enhanced operations at the base-station, the enhanced operations at UE are just exemplary. Enhanced operations are designed to be open-ended, allowing for diverse individual implementations that hold potential for significant commercial benefits. Again, central to realizing these benefits is the presence of a universal TS analysis engine capable of conducting real-time TS analysis across multiple sources and modalities of TS data and a fast and reliable connection to that universal TS analysis engine.

As described, versatile wireless system is provided, where the base-station not only manages and optimizes network operations using a universal TS analysis engine but also extends these advanced functionalities to a diverse range of UEs.
(1). Optimized resource allocation: With the integration of a universal TS analysis engine at the base-station, there may be a significant enhancement in the allocation of resources. The base-station may more efficiently allocate frequency bands, time slots, and power levels to UEs based on predictive insights, helping to optimize data flow and minimize potential bottlenecks. Several benefits are described below.
(2). Proactive system adjustments: The ability to predict varying channel environments based on multi-modality real-time data allows the base-station to make proactive adjustments. This may help operations such as scheduling, power control, beamforming, and interference management to be executed more reliably and swiftly.
(3). Enhanced user experience: UEs can access the universal TS analysis engine functions at the base-station. This access may allow individual UEs to gain insights into their surroundings, leading to more tailored predictions and a more personalized user experience.
(4). Seamless integration with UEs: The embodiment facilitates a two-way interaction between the base-station and UEs. UEs can send their TS data to the base-station for TS analysis and prediction. In return, they receive insights that can be used to help optimize their operations, which may help create a more harmonized and efficient system.
(5). Advantages of cellular wireless connections: The embodiment's design, which utilizes wireless connections in a cellular environment, offers distinct advantages:
(6). Reduced latency: By having the universal TS analysis engine in close proximity within the cellular environment, data transmission delays may be minimized, leading to faster response times and real-time insights.
(7). Unified environment analysis: Both UEs and the base-station exist within the same cellular environment. This shared context may allow for more accurate and relevant TS analysis engine, as the data being analyzed is from the same environmental conditions.
(8). Wireless over wired: Wireless connections, especially in a cellular setup, offer more flexibility and adaptability compared to wired connections. This makes the integration and communication between UEs and the base-station more seamless and efficient.
(9). Future-proofing the wireless system: As wireless technology evolves, the demands on the system will increase. The embodiment's ability to provide real-time, multi-modality TS analysis may help the system to be more adaptable and ready to handle future challenges, making it future-proof.
(10). Cost and time efficiency: By centralizing the universal TS analyzer engine at the base-station, there's a reduction in the need for individual UEs to have their own dedicated TS analysis sub-systems. This reduces costs and helps ensure that predictions and analyses are consistent across the network.

In summary, the TS analysis system or the TS analysis method described presents a novel approach to integrating a universal TS analysis engine within a wireless system, especially considering the cellular environment. This integration offers numerous benefits, from optimized resource allocation to the unique advantages of cellular wireless connections.

In the evolving landscape of wireless systems, as embodiment described with FIG. 13, there emerges a pressing need to manage the burgeoning array of embedding encoders and soft-prompt generators situated at the UEs. These components, typically realized using deep neural networks, cater to the diverse nature of UEs and their specific TS data types. Efficiently managing this multitude becomes important to provide more seamless and optimized operations.

According to some embodiments, the functionalities of the universal TS analysis engine are hosted on a cloud platform. The base-station accesses these services as and when required, increasing scalability, flexibility, and the potential for remote updates.

Referring to FIG. 14, a Life-Cycle of Embedding Encoders and Soft-Prompt Generators is shown in FIG. 14.

Registering: This is the phase where an embedding encoder or a soft-prompt generator, both typically realized as deep neural networks, is registered within the system to cater to a specific type of TS data.

Distributing: Once registered, the model is disseminated either to specific UEs or across the network, depending on its applicability.

Applying: UEs utilize the received models to generate semantic embeddings and soft-prompts for their TS data.

Updating: Over time, as the nature of TS data evolves or as better models are developed, these components may be updated to maintain or increase performance.

Retiring: When a model becomes obsolete or is superseded by a more efficient version, it is phased out from the system.

According to some embodiments, Network-Administered Life-Cycle Management includes the following phases. These phases show the process of embedding encoders and soft-prompt generators from commissioning to retirement in implementations led by network.

In this approach, the entire life-cycle of the embedding encoders and soft-prompt generators is overseen by the network through the base-station.
(1). Registering& Updating: The network, recognizing the need for a new or updated model, initiates its registration or modification.
Physical Channel: PDCCH
Control Message: Model Registration/Update Request

Procedure: The network, through the base-station, sends a control message over the PDCCH to the UEs, indicating the need for model registration or an update. UEs acknowledge the receipt of this message using the PUCCH. If a UE has a new or updated model, it prepares the model data for transmission.
(2). Distributing: The base-station then distributes these models to the UEs wirelessly.
Physical Channel: PDSCH
Control Message: Model Distribution Command

Procedure: The base-station, after collating the necessary model data, sends a command over the PDCCH to notify UEs of the impending model distribution. The actual model data (embedding encoder and soft-prompt generator parameters) are then transmitted over the PDSCH. UEs, upon successfully receiving the model data, send an acknowledgment over the PUCCH.
(3). Applying: UEs apply these models as per their TS data requirements.
Physical Channel: PUCCH
Control Message: Model Application Acknowledgment

Procedure: Once UEs receive the model data, they apply these models to their TS data generation process. After successful application, UEs send an acknowledgment message over the PUCCH to inform the base-station of the successful model application.
(4). Retiring: The network, upon identifying obsolescence, sends commands to retire specific models from the UEs.
Physical Channel: PDCCH
Control Message: Model Retirement Command

Procedure: The network, upon deciding to retire a model, sends a retirement command to the UEs over the PDCCH. UEs, upon receiving this command, retire the specified model from their operations. An acknowledgment of the model retirement is then sent by the UEs over the PUCCH.

According to some embodiments, UE-Administered Life-Cycle Management includes the following phases. These phases show the process of embedding encoders and soft-prompt generators from commissioning to retirement in implementations led by UE.

Here, the UEs take a more proactive role in the life-cycle management of the embedding encoders and soft-prompt generators.
(1). Registering & Updating: UEs, based on their specific needs, register or update their models.
Physical Channel: PUCCH
Control Message: Model Registration/Update Notification

Procedure: UEs, based on their specific needs or after developing/updating a model, send a notification over the PUCCH to the base-station indicating the registration or update of their models. The base-station acknowledges the receipt of this message using the PDSCH.
(2). Distributing: While UEs might share beneficial models amongst themselves, the primary distribution remains internal.
Physical Channel: PUSCH& PDSCH
Control Message: Model Sharing Request & Model Sharing Data

Procedure: If UEs decide to share models amongst themselves, a sharing request is sent over the PUCCH. Upon approval (either autonomously or by the network), the actual model data is transmitted from the sharing UE over the PUSCH and received by the recipient UE over the PDSCH.
(3). Applying: UEs autonomously apply these models to their TS data.

Procedure: UEs autonomously apply the registered or updated models to their TS data without requiring explicit channel communication for this step.
(4). Notifying: For network awareness, UEs notify the network of their models through the base-station. This helps ensure that the network has visibility into the models being used.
Physical Channel: PUCCH
Control Message: Model Usage Notification

Procedure: For network visibility, after applying a model, UEs send a notification over the PUCCH to inform the base-station of the models they're using. The base-station acknowledges the receipt of this usage notification using the PDSCH.
(5). Retiring: UEs decide on the retirement of models based on their evolving needs and inform the network accordingly.
Control Message: Model Retirement Notification

Procedure: UEs, upon deciding to retire a model based on their evolving needs, send a retirement notification over the PUCCH. The base-station acknowledges the receipt of this retirement notification using the PDSCH.

In this embodiment, the following effects can be realized by life cycle management. Decentralized flexibility: By allowing UEs to register, update, and manage their embedding encoders and soft-prompt generators, the system promotes a decentralized approach. This allows the UEs to more swiftly adapt to their specific needs without waiting for centralized directives, enhancing responsiveness and adaptability.

Optimized network resources: The embodiment reduces the overhead on the central network. By offloading the responsibility of model management to UEs, the network can better allocate its resources to other critical tasks, leading to improved overall system efficiency. The DNN models of embedding encoders and soft-prompt generators are far smaller (0.05%) of an LLM model.

Tailored user experience: As UEs have the autonomy to select and manage models best suited to their requirements, users benefit from a more personalized and optimized experience. This tailored approach helps provide TS analysis and predictions that may be more accurate and relevant to individual UEs.

Enhanced network visibility: Despite the decentralized model management, the embodiment may help the network to remain informed about the models in use. This visibility may allow the network to make informed decisions, which may provide more harmonized operations and help to prevent potential conflicts.

Scalability: The system is inherently scalable. As the number of UEs and their diverse needs grow, the embodiment may allow the system to accommodate these variations without significant modifications to the central infrastructure.

Reduced latency: By empowering UEs to manage their models and only communicate essential notifications to the base-station, the system may minimize unnecessary back-and-forth communications. This reduction in communication may lead to decreased latency, which may help to ensure real-time or near-real-time TS analysis and predictions.

Future-proofing: The flexible and adaptive nature of this embodiment may help to ensure that, as new types of TS data emerge or as user needs evolve, the system can accommodate these changes. This adaptability may improve the system's longevity and relevance in future wireless scenarios.

Efficient model sharing: The embodiment may facilitate efficient model sharing among UEs. This peer-to-peer sharing approach may help beneficial models to be disseminated quickly, leading to collective system enhancement.

Resource conservation: By transmitting TS in semantic embedding rather than raw TS data, the system may provide more efficient use of bandwidth. This conservation of resources leads to cost savings and improved system performance.

In summary, embodiment of cycle management presents a forward-thinking approach to managing embedding encoders and soft-prompt generators in a wireless system. By balancing UE autonomy with network visibility and coordination, the system may achieve more optimized operations, helping to provide a more robust and efficient wireless environment.

Illustratively, referring to FIG. 15, FIG. 15 shows a schematic block diagram of an apparatus according to some embodiments of this disclosure. The apparatus 1000 includes a processor 1010. The processor 1010 is coupled to a memory 1020. The memory 1020 is configured to store a computer program or instructions and/or data. The processor 1010 is configured to execute the computer program or instructions and/or data stored in the memory 1020, so that the methods in the foregoing method embodiments are executed.

In some embodiments, the apparatus 1000 includes one or more processors 1010.

In some embodiments, as shown in FIG. 15, the apparatus 1000 may further include the memory 1020.

In some embodiments, the apparatus 1000 may include one or more memories 1020.

In some embodiments, the memory 1020 may be integrated with the processor 1010, or disposed separately from the processor 1010.

In some embodiments, as shown in FIG. 15, the apparatus 1000 may further include a communication interface 1030, and the communication interface 1030 is configured to communication with other apparatus/chips/device/chipset. For example, the processor 1010 is configured to receive a signal across a receiver or transmit a signal across a transmitter based on the communication interface 1030. For another example, the processor 1010 may store data to a memory or read data from a memory based on the communication interface 1030.

In some embodiments, the detail description of processor 1010 may refer to the processor 210/260/276 described below.

In some embodiments, the detail description of memory 1020 may refer to the memory 208/258/278 described below.

In some embodiments, the apparatus 1000 may comprise more modules.

In some embodiments, the apparatus 1000 may be applied as a BS or UE. And the apparatus 1000 may execute instructions to realize the steps executed in FIG. 10, FIG. 11 or FIG. 13.

In some embodiments, the apparatus 1000 might be a chip or a chipset.

Referring to FIG. 16, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

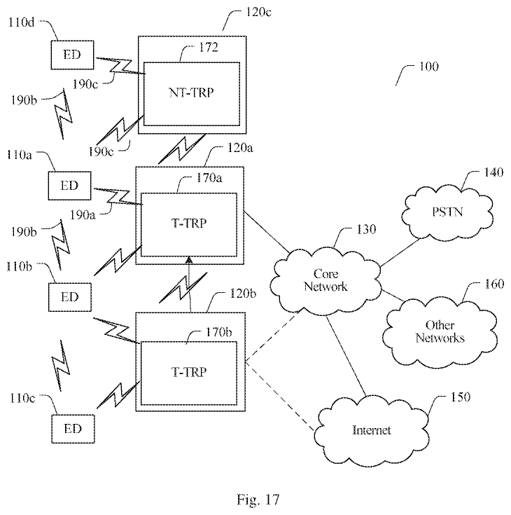

FIG. 17 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

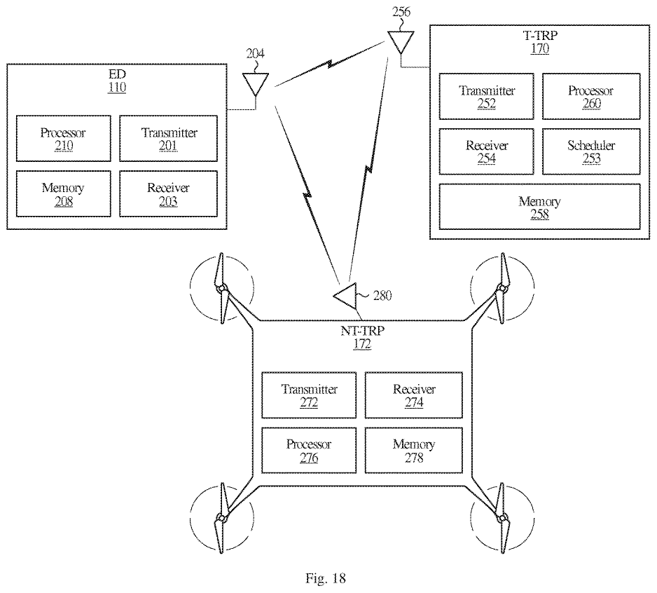

FIG. 18 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 18, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 16). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. PDCCH, and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

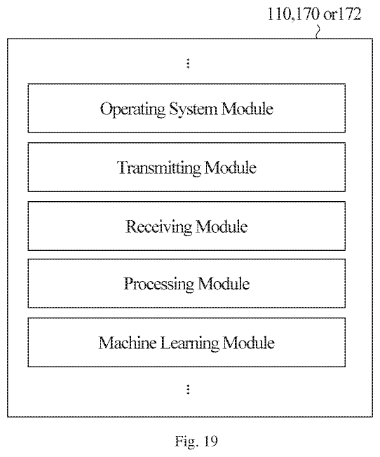

One or more steps of the embodiment methods provided herein may be performed by corresponding units or modules, according to FIG. 19. FIG. 19 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Artificial Intelligence technologies can be applied in communication, including artificial intelligence or machine learning (AI/ML) based communication in the physical layer and/or AI/ML based communication in the higher layer, e.g., medium access control (MAC) layer. For example, in the physical layer, the AI/ML based communication may aim to optimize component design and/or improve the algorithm performance. For the MAC layer, the AI/ML based communication may aim to utilize the AI/ML capability for learning, prediction, and/or making a decision to solve a complicated optimization problem with possible better strategy and/or optimal solution, e.g. to optimize the functionality in the MAC layer, e.g. intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

The following are some terminologies which are used in AI/ML field:

### Data Collection

Data is the very important component for AI/ML techniques. Data collection is a process of collecting data by the network nodes, management entity, or UE for the purpose of AI/ML model training, data analytics and inference.

### AI/ML Model Training

AI/ML model training is a process to train an AI/ML Model by learning the input/output relationship in a data driven manner and obtain the trained AI/ML Model for inference.

### AI/ML Model Inference

A process of using a trained AI/ML model to produce a set of outputs based on a set of inputs.

### AI/ML Model Validation

As a sub-process of training, validation is used to evaluate the quality of an AI/ML model using a dataset different from the one used for model training. Validation can help selecting model parameters that generalize beyond the dataset used for model training. The model parameter after training can be adjusted further by the validation process.

### AI/ML Model Testing

Similar with validation, testing is also a sub-process of training, and it is used to evaluate the performance of a final AI/ML model using a dataset different from the one used for model training and validation. Differently from AI/ML model validation, testing do not assume subsequent tuning of the model.

### Online Training:

Online training means an AI/ML training process where the model being used for inference is typically continuously trained in (near) real-time with the arrival of new training samples.

### Offline Training:

An AI/ML training process where the model is trained based on collected dataset, and where the trained model is later used or delivered for inference.

### AI/ML Model Delivery/Transfer

A generic term referring to delivery of an AI/ML model from one entity to another entity in any manner. Delivery of an AI/ML model over the air interface includes either parameters of a model structure known at the receiving end or a new model with parameters. Delivery may contain a full model or a partial model.

### Life Cycle Management (LCM)

When the AI/ML model is trained and/or inferred at one device, it is necessary to monitor and manage the whole AI/ML process to guarantee the performance gain obtained by AI/ML technologies. For example, due to the randomness of wireless channels and the mobility of UEs, the propagation environment of wireless signals changes frequently. Nevertheless, it is difficult for an AI/ML model to maintain optimal performance in all scenarios for all the time, and the performance may even deteriorate sharply in some scenarios. Therefore, the lifecycle management (LCM) of AI/ML models is important for sustainable operation of AI/ML in NR air-interface.

Life cycle management covers the whole procedure of AI/ML technologies which applied on one or more nodes. In specific, it includes at least one of the following sub-process: data collection, model training, model identification, model registration, model deployment, model configuration, model inference, model selection, model activation, deactivation, model switching, model fallback, model monitoring, model update, model transfer/delivery and UE capability report.

Model monitoring can be based on inference accuracy, including metrics related to intermediate key performance indicator (KPI) s, and it can also be based on system performance, including metrics related to system performance KPIs, e.g., accuracy and relevance, overhead, complexity (computation and memory cost), latency (timeliness of monitoring result, from model failure to action) and power consumption. Moreover, data distribution may shift after deployment due to the environment changes, thus the model based on input or output data distribution should also be considered.

The goal of supervised learning algorithms is to train a model that maps feature vectors (inputs) to labels (output), based on the training data which includes the example feature-label pairs. The supervised learning can analyze the training data and produce an inferred function, which can be used for mapping the inference data.

Supervised learning can be further divided into two types: Classification and Regression. Classification is used when the output of the AI/ML model is categorical i.e. with two or more classes. Regression is used when the output of the AI/ML model is a real or continuous value.

In contrast to supervised learning where the AI/ML models learn to map the input to the target output, the unsupervised methods learn concise representations of the input data without the labelled data, which can be used for data exploration or to analyze or generate new data. One typical unsupervised learning is clustering which explores the hidden structure of input data and provide the classification results for the data.

Reinforce learning is used to solve sequential decision-making problems. Reinforce learning is a process of training the action of intelligent agent from input (state) and a feedback signal (reward) in an environment. In reinforce learning, an intelligent agent interacts with an environment by taking an action to maximize the cumulative reward. Whenever the intelligent agent takes one action, the current state in the environment may transfer to the new state, and the new state resulted by the action will bring to the associated reward. Then the intelligent agent can take the next action based on the received reward and new state in the environment. During the training phase, the agent interacts with the environment to collect experience. The environments often mimicked by the simulator since it is expensive to directly interact with the real system. In the inference phase, the agent can use the optimal decision-making rule learned from the training phase to achieve the maximal accumulated reward.

Federated learning (FL) is a machine learning technique that is used to train an AI/ML model by a central node (e.g., server) and a plurality of decentralized edge nodes (e.g., UEs, next Generation NodeBs, “gNBs”).

According to the wireless FL technique, a server may provide, to an edge node, a set of model parameters (e.g., weights, biases, gradients) that describe a global AI/ML model. The edge node may initialize a local AI/ML model with the received global AI/ML model parameters. The edge node may then train the local AI/ML model using local data samples to, thereby, produce a trained local AI/ML model. The edge node may then provide, to the serve, a set of AI/ML model parameters that describe the local AI/ML model.

Upon receiving, from a plurality of edge nodes, a plurality of sets of AI/ML model parameters that describe respective local AI/ML models at the plurality of edge nodes, the server may aggregate the local AI/ML model parameters reported from the plurality of UEs and, based on such aggregation, update the global AI/ML model. A subsequent iteration progresses much like the first iteration. The server may transmit the aggregated global model to a plurality of edge nodes. The above procedure are performed multiple iterations until the global AI/ML model is considered to be finalized, e.g., the AI/ML model is converged or the training stopping conditions are satisfied.

Notably, the wireless FL technique does not involve exchange of local data samples. Indeed, the local data samples remain at respective edge nodes.

AI technologies (which encompass ML technologies) may be applied in communication, including AI-based communication in the physical layer and/or AI-based communication in the MAC layer. For the physical layer, the AI communication may aim to optimize component design and/or improve the algorithm performance. For example, AI may be applied in relation to the implementation of: channel coding, channel modelling, channel estimation, channel decoding, modulation, demodulation, MIMO, waveform, multiple access, physical layer element parameter optimization and update, beam forming, tracking, sensing, and/or positioning, etc. For the MAC layer, the AI communication may aim to utilize the AI capability for learning, prediction, and/or making a decision to solve a complicated optimization problem with possible better strategy and/or optimal solution, e.g. to optimize the functionality in the MAC layer. For example, AI may be applied to implement: intelligent TRP management, intelligent beam management, intelligent channel resource allocation, intelligent power control, intelligent spectrum utilization, intelligent MCS, intelligent HARQ strategy, and/or intelligent transmission/reception mode adaption, etc.

An AI architecture may involve multiple nodes, where the multiple nodes may possibly be organized in one of two modes, i.e., centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, e.g., distributed machine learning and federated learning. In some embodiments, an AI architecture may comprise an intelligent controller which can perform as a single agent or a multi-agent, based on joint optimization or individual optimization. New protocols and signaling mechanisms are desired so that the corresponding interface link can be personalized with customized parameters to meet particular requirements while minimizing signaling overhead and maximizing the whole system spectrum efficiency by personalized AI technologies.

New protocols and signaling mechanisms are provided for operating within and switching between different modes of operation, including between AI and non-AI modes, and for measurement and feedback to accommodate the different possible measurements and information that may need to be fed back, depending upon the implementation.

An air interface that uses AI as part of the implementation, e.g. to optimize one or more components of the air interface, will be referred to herein as an “AI enabled air interface”. In some embodiments, there may be two types of AI operation in an AI enabled air interface: both the network and the UE implement learning; or learning is only applied by the network.

### Definitions of Acronyms & Glossaries

LTE Long Term Evolution
NR New Radio
BWP Bandwidth part
BS Base Station
CA Carrier Aggregation
CC Component Carrier
CG Cell Group
CSI Channel state information
CSI-RS Channel state information Reference Signal
DC Dual Connectivity
DCI Downlink control information
DL Downlink
DL-SCH Downlink shared channel
EN-DC E-UTRA NR dual connectivity with MCG using E-UTRA and SCG using NR
NB Next generation (or 5G) base station
HARQ-ACK Hybrid automatic repeat request acknowledgement
MCG Master cell group
MCS Modulation and coding scheme
MAC-CE Medium Access Control-Control Element
PBCH Physical broadcast channel
PCell Primary cell
PDCCH Physical downlink control channel
PDSCH Physical downlink shared channel
PRACH Physical Random Access Channel
PRG Physical resource block group
PSCell Primary SCG Cell
PSS Primary synchronization signal
PUCCH Physical uplink control channel
PUSCH Physical uplink shared channel
RACH Random access channel
RAPID Random access preamble identity
RB Resource block
RE Resource element
RRM Radio resource management
RMSI Remaining system information
RS Reference signal
RSRP Reference signal received power
RRC Radio Resource Control
SCG Secondary cell group
SFN System frame number
SL Sidelink
SCell Secondary Cell
SPS Semi-persistent scheduling
SR Scheduling request
SRI SRS resource indicator
SRS Sounding reference signal
SSS Secondary synchronization signal
SSB Synchronization Signal Block
SUL Supplement Uplink
TA Timing advance
TAG Timing advance group
TUE target UE
UCI Uplink control information
UE User Equipment
UL Uplink
UL-SCH Uplink shared channel

What is claimed is:

1. A time series (TS) analysis method applied to a first device, comprising:
obtaining TS data; and
performing TS analysis on the TS data based on a first model to obtain TS analysis result, wherein:
when the TS data is of a first type, the first model includes a first embedded encoder corresponding to the first type; or
when the TS data is of a second type, the first model includes a second embedded encoder corresponding to the second type.

2. The method of claim 1, wherein the first model further includes a large language model (LLM), and
the performing TS analysis on the TS data based on a first model comprises:
converting the TS data into TS semantic embedding feature data by the first embedded encoder or the second embedded encoder; and
processing the TS semantic embedding feature data with the LLM of the first model to obtain the TS analysis result.

3. The method of claim 1, wherein the performing TS analysis on the TS data based on a first model comprises:
performing TS analysis on the TS data based on the first model and a soft prompt, wherein:
when the TS data is of the first type, the soft prompt is a first soft prompt; or
when the TS data is of the second type, the soft prompt is a second soft prompt.

4. The method of claim 1, wherein the first model dynamically updates parameters of the first model based on the TS data.

5. The method of claim 1, further comprising:
sending a TS analysis request to a second device; and
wherein the obtaining TS data comprises:
receiving first data from the second device, wherein the first data is the TS data or a first part of the TS data.

6. The method of claim 1, further comprising:
receiving a TS analysis request from a second device; and
sending a grant message to the second device.

7. An apparatus comprising:
at least one processor coupled with at least one non-transitory computer readable medium storing instructions that, when executed by the at least one processor, cause the apparatus to perform operations comprising:
obtaining time series (TS) data; and
performing TS analysis on the TS data based on a first model to obtain TS analysis result, wherein:
when the TS data is of a first type, the first model includes a first embedded encoder corresponding to the first type; or
when the TS data is of a second type, the first model includes a second embedded encoder corresponding to the second type.

8. The apparatus of claim 7, wherein the first model further includes a large language model (LLM), and
the performing TS analysis on the TS data based on a first model comprises:
converting the TS data into TS semantic embedding feature data by the first embedded encoder or the second embedded encoder; and
processing the TS semantic embedding feature data with the LLM of the first model to obtain the TS analysis result.

9. The apparatus of claim 7, wherein the performing TS analysis on the TS data based on a first model comprises:
performing TS analysis on the TS data based on the first model and a soft prompt, wherein:
when the TS data is of the first type, the soft prompt is a first soft prompt; or
when the TS data is of the second type, the soft prompt is a second soft prompt.

10. The apparatus of claim 7, wherein the first model dynamically updates parameters of the first model based on the TS data.

11. The apparatus of claim 7, wherein the apparatus is a first device, and wherein the operations further comprise:
sending a TS analysis request to a second device; and
wherein the obtain TS data, comprises:
receiving first data from the second device, wherein the first data is the TS data or a first part of the TS data.

12. The apparatus of claim 7, wherein the apparatus is a first device, and wherein the operations further comprise:
receiving a TS analysis request from a second device; and
sending a grant message to the second device.

13. The apparatus of claim 11, wherein the obtaining TS data comprises:
obtaining second data from a sensor, wherein the second data is the TS data or a second part of the TS data.

14. The apparatus of claim 7, wherein the apparatus is a first device, and wherein the operations further comprise:
sending the TS analysis result to a second device.

15. A non-transitory computer readable medium storing instructions that, when executed by at least one processor, cause an apparatus to perform operations comprising:
obtaining time series (TS) data; and
performing TS analysis on the TS data based on a first model to obtain TS analysis result, wherein:
when the TS data is of a first type, the first model includes a first embedded encoder corresponding to the first type; or
when the TS data is of a second type, the first model includes a second embedded encoder corresponding to the second type.

16. The non-transitory computer readable medium of claim 15, wherein the first model further includes a large language model (LLM), and
the performing TS analysis on the TS data based on a first model comprises:
converting the TS data into TS semantic embedding feature data by the first embedded encoder or the second embedded encoder; and
processing the TS semantic embedding feature data with the LLM of the first model to obtain the TS analysis result.

17. The non-transitory computer readable medium of claim 15, wherein the performing TS analysis on the TS data based on a first model comprises:
performing TS analysis on the TS data based on the first model and a soft prompt, wherein:
when the TS data is of the first type, the soft prompt is a first soft prompt; or
when the TS data is of the second type, the soft prompt is a second soft prompt.

18. The non-transitory computer readable medium of claim 15, wherein the first model dynamically updates parameters of the first model based on the TS data.

19. The non-transitory computer readable medium of claim 15, wherein the apparatus is a first device, and wherein the operations further comprise:
sending a TS analysis request to a second device; and
wherein the obtaining TS data, comprises:
receiving a first data from the second device, wherein the first data is the TS data or a first part of the TS data.

20. The non-transitory computer readable medium of claim 15, wherein the apparatus is a first device, and wherein the operations further comprise:
receiving a TS analysis request from a second device; and
sending a grant message to the second device.
